(19) United States
(12) Patent Application Publication
(10) Pub. No.: US 2009/0073943 A1
(43) Pub. Date: Mar. 19, 2009

(54) HETEROGENEOUS WIRELESS AD HOC NETWORK

(75) Inventors: Dilip Krishnaswamy, San Diego, CA (US); Atul Suri, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/192,833

(22) Filed: Aug. 15, 2008

Related U.S. Application Data
(60) Provisional application No. 60/956,658, filed on Aug. 17, 2007.
(60) Provisional application No. 60/980,547, filed on Oct. 17, 2007.
(60) Provisional application No. 60/980,557, filed on Oct. 17, 2007.
(60) Provisional application No. 60/980,575, filed on Oct. 17, 2007.
(60) Provisional application No. 60/980,565, filed on Oct. 17, 2007.

(51) Int. Cl. H04W 4/00

(52) U.S. Cl. 370/338

(57) ABSTRACT

A heterogeneous wireless ad-hoc network includes a server and a number of ad-hoc service providers that provide connectivity to a network for mobile clients. The mobile client is configured to search for ad-hoc service providers with wireless backhauls to the network and associate with one of the ad-hoc service providers detected in the search based on one or more parameters.

### CLAIM OF PRIORITY UNDER 35 U.S.C. §119

The present Application for patent claims priority to Provisional Application No. 60/956,658, entitled “Method for a Heterogeneous Wireless Ad Hoc Mobile Service Provider,” filed Aug. 17, 2007; Provisional Application No. 60/980,547, entitled “Service Set Manager for Ad Hoc Mobile Service Provider,” filed Oct. 17, 2007; Provisional Application No. 60/980,557, entitled “Handoff In Ad-Hoc Mobile Broadband Exchange,” filed Oct. 17, 2007; Provisional Application No. 60/980,575, entitled “Ad Hoc Service Provider Topology,” filed Oct. 17, 2007; and Provisional Application No. 60/980,565 entitled “System and Method for Acquiring or Distributing Information Related to One or More Alternate Ad Hoc Service Providers,” filed Oct. 17, 2007. The contents of these disclosures are expressly incorporated by reference herein.

### CLAIM OF PRIORITY UNDER 35 U.S.C. §120

The present Application claims priority under 35 U.S.C. §120 to U.S. patent application Ser. No. 11/840,905, entitled “Method for a Heterogeneous Wireless Ad Hoc Mobile Service Provider,” filed Aug. 17, 2007, pending; U.S. patent application Ser. No. 11/840,910, entitled “Method for a Heterogeneous Wireless Ad Hoc Mobile Internet Access Service,” filed Aug. 17, 2007, pending; U.S. patent application Ser. No. 11/861,280, entitled “Ad Hoc Service Provider Configuration for Broadcasting Service Information,” filed Sep. 26, 2007, pending, which claims priority to Provisional Application No. 60/956,658, entitled “Method for a Heterogeneous Wireless Ad Hoc Mobile Service Provider,” filed Aug. 17, 2007; U.S. patent application Ser. No. 11/861,279, entitled “Ad Hoc Service Provider's Ability to Provide Service for a Wireless Network,” filed Sep. 26, 2007, pending, which claims priority to Provisional Application No. 60/956,658, entitled “Method for a Heterogeneous Wireless Ad Hoc Mobile Service Provider,” filed Aug. 17, 2007; U.S. patent application Ser. No. 12/188,979, entitled “Service Set Manager for Ad Hoc Mobile Service Provider,” filed Aug. 8, 2008, pending, which claims priority to Provisional Application Nos. 60/956,658, entitled “Method for a Heterogeneous Wireless Ad Hoc Mobile Service Provider,” filed Aug. 17, 2007, and 60/980,547, entitled “Service Set Manager for Ad Hoc Mobile Service Provider,” filed Oct. 17, 2007; U.S. patent application Ser. No. 12/188,985, entitled “Handoff in Ad-Hoc Mobile Broadband Networks,” filed Aug. 8, 2008, pending, which claims priority to Provisional Application Nos. 60/956,658, entitled “Method for a Heterogeneous Wireless Ad Hoc Mobile Service Provider,” filed Aug. 17, 2007, and 60/980,557, entitled “Handoff In Ad-Hoc Mobile Broadband Exchange,” filed Oct. 17, 2007; U.S. patent application Ser. No. 12/147,231, entitled “Ad Hoc Service Provider Topology,” filed Jun. 26, 2008, pending, which claims priority to Provisional Application Nos. 60/956,658, entitled “Method for a Heterogeneous Wireless Ad Hoc Mobile Service Provider,” filed Aug. 17, 2007, and 60/980,575, entitled “Ad Hoc Service Provider Topology,” filed Oct. 17, 2007; U.S. patent application Ser. No. 12/147,240, entitled “System and Method for Acquiring or Distributing Information Related to One or More Alternate Ad Hoc Service Providers,” filed Jun. 26, 2008, pending, which claims priority to Provisional Application Nos. 60/956,658, entitled “Method for a Heterogeneous Wireless Ad Hoc Mobile Service Provider,” filed Aug. 17, 2007, and 60/980,565 entitled “System and Method for Acquiring or Distributing Information Related to One or More Alternative Ad Hoc Service Providers,” filed Oct. 17, 2007; U.S. patent application Ser. No. 12/188,990, entitled “Handoff at an Ad-Hoc mobile Service Provider,” filed Aug. 8, 2008, pending, which claims priority to Provisional Application Nos. 60/956,658, entitled “Method for a Heterogeneous Wireless Ad Hoc Mobile Service Provider,” filed Aug. 17, 2007, and 60/980,557, entitled “Handoff In Ad-Hoc Mobile Broadband Exchange,” filed Oct. 17, 2007; and U.S. patent application Ser. No. 12/189,008, entitled “Security for a Heterogeneous Ad Hoc Mobile Broadband Network,” filed Aug. 8, 2008, pending, which claims priority to Provisional Application No. 60/956,658, entitled “Method for a Heterogeneous Wireless Ad Hoc Mobile Service Provider,” filed Aug. 17, 2007. The contents of these disclosures are expressly incorporated by reference herein.

### BACKGROUND

1. Field

The present disclosure relates generally to telecommunications, and more specifically to heterogeneous wireless ad-hoc networks.

2. Background

Wireless telecommunication systems are widely deployed to provide various services to consumers, such as telephony, data, video, audio, messaging, broadcasts, etc. These systems continue to evolve as market forces drive wireless telecommunications to new heights. Today, wireless networks are providing broadband Internet access to mobile subscribers over a regional, a nationwide, or even a global region. Such networks are sometimes referred as Wireless Wide Area Networks (WWANs). WWAN operators generally offer wireless access plans to their subscribers such as subscription plans at a monthly fixed rate.

Accessing WWANs from all mobile devices may not be possible. Some mobile devices may not have a WWAN radio. Other mobile devices with a WWAN radio may not have a subscription plan enabled. Ad-hoc networking allows mobile devices to dynamically connect over wireless interfaces using protocols such as WLAN, Bluetooth, UWB or other protocols. There is a need in the art for a methodology to allow a user of a mobile device without WWAN access to dynamically subscribe to wireless access service provided by a user with a WWAN-capable mobile device using wireless ad-hoc networking between the mobile devices belonging to the two users.

### SUMMARY

In one aspect of the disclosure, a mobile client includes a processing system configured to search for ad-hoc service providers with wireless backhauls to a network, the processing system being further configured to associate with one of the ad-hoc service providers detected in the search based on one or more parameters.

In another aspect of the disclosure, a mobile client includes means for search for ad-hoc service providers with wireless backhauls to a network, and means for associating with one of the ad-hoc service providers detected in the search based on one or more parameters.

In yet another aspect of the disclosure, a method of accessing a network through an ad-hoc service provider includes searching for ad-hoc service providers with wireless backhauls to a network, and associating with one of the ad-hoc service providers detected in the search based on one or more parameters.

In a further aspect of the disclosure, a machine-readable medium includes instructions executable by a processing system in a mobile client, the instructions include code for searching for ad-hoc service providers with wireless backhauls to a network, and code for associating with one of the ad-hoc service providers detected in the search based on one or more parameters.

It is understood that other aspects of the disclosure will become readily apparent to those skilled in the art from the following detailed description, wherein various aspects of heterogeneous wireless ad-hoc n networks are shown and described by way of illustration. As will be realized, these aspects of the disclosure may be implemented in other and different configurations and its several details are capable of modification in various other respects. Accordingly, the drawings and detailed description are to be regarded as illustrative in nature and not as restrictive.

### BRIEF DESCRIPTION OF THE DRAWINGS

FIG. 1 is a simplified diagram illustrating an example of a telecommunications system;

FIG. 2 is a simplified diagram illustrating an example of a hardware implementation for a server;

FIG. 3 is a simplified diagram illustrating an example of a hardware implementation for a processing system in a server;

FIG. 4 is a flow diagram illustrating an example of the functionality of various software modules in a processing system of a server;

FIG. 5 is a simplified diagram illustrating an example of a handoff of a mobile client in a telecommunications system;

FIG. 6 is a flow diagram illustrating an example of the functionality of various software modules in a processing system of a server supporting a handoff of a mobile client in a telecommunications system;

FIG. 7 is a simplified diagram illustrating an example of the functionality of an ad-hoc service provider;

FIG. 8 is a flow diagram illustrating an example of the functionality of a service provider application in an ad-hoc service provider;

FIG. 9 is a simplified diagram illustrating an example of a hardware configuration for a processing system in an ad-hoc service provider;

FIG. 10 is a simplified diagram illustrating an example of a hardware implementation for a mobile client;

FIG. 11 is a simplified diagram illustrating an example of a hardware implementation for a processing system in a mobile client;

FIG. 12 is a flow diagram illustrating an example of the functionality of various software module in a processing system of a mobile client; and

FIG. 13 is a call flow diagram illustrating an example of various signaling to perform a handoff of a mobile client in a telecommunications system.

### DETAILED DESCRIPTION

The detailed description set forth below in connection with the appended drawings is intended as a description of various aspects of heterogeneous wireless ad-hoc networks and is not intended to represent the only implementations to which such aspects apply. As those skilled in the art will readily understand, the various aspects of heterogeneous wireless ad-hoc networks described throughout this disclosure may be extended to other telecommunication applications. The detailed description includes specific details for the purpose of providing a thorough understanding of the disclosed subject matter. However, it will be apparent to those skilled in the art that various aspects heterogeneous wireless ad-hoc networks may be practiced without these specific details. In some instances, well-known structures and components are shown in block diagram form in order to avoid obscuring the various concepts presented throughout this disclosure.

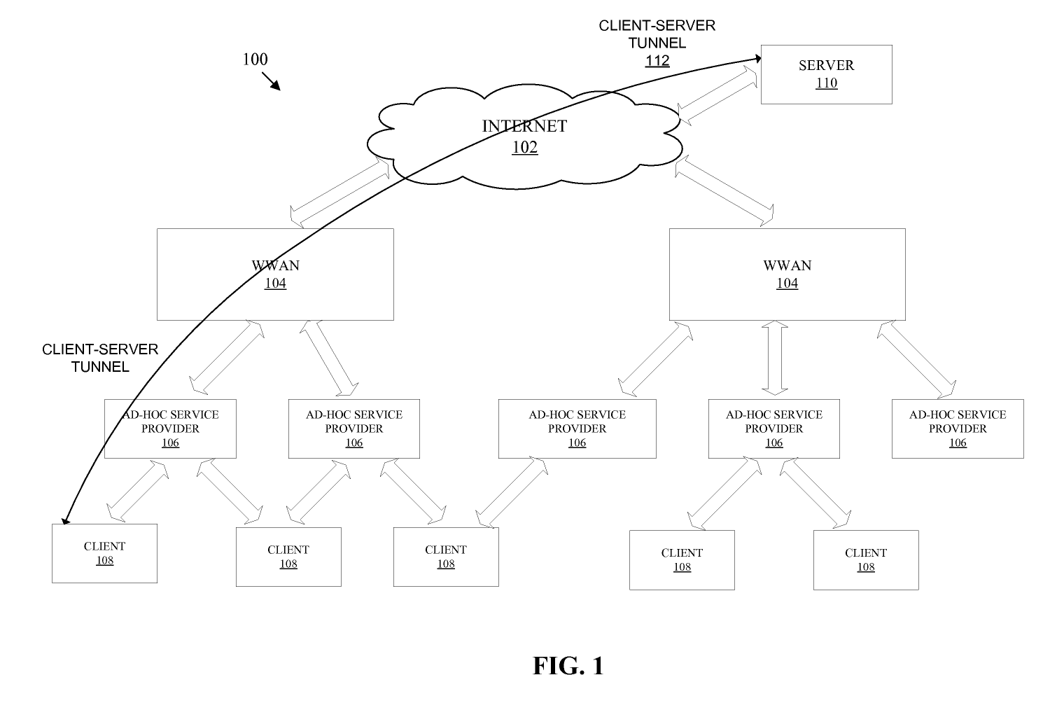

FIG. 1 is a simplified block diagram illustrating an example of a telecommunications system. The telecommunications system 100 is shown with multiple WWANs that provide broadband access to a network infrastructure 102 for mobile subscribers. The network infrastructure 102 may be a packet-based network such as the Internet or some other suitable network infrastructure. For clarity of presentation, two WWANs 104 are shown with a backhaul connection to the Internet 102. Each WWAN 104 may be implemented with multiple fixed-site base stations (not shown) dispersed throughout a geographic region. The geographic region may be generally subdivided into smaller regions known as cells. Each base station may be configured to serve all mobile subscribers within its respective cell. A base station controller (not shown) may be used to manage and coordinate the base stations in the WWAN 104 and support the backhaul connection to the Internet 102.

Each WWAN 104 may use one of many different wireless access protocols to support radio communications with mobile subscribers. By way of example, one WWAN 104 may support Evolution-Data Optimized (EV-DO), while the other WWAN 104 may support Ultra Mobile Broadband (UMB). EV-DO and UMB are air interface standards promulgated by the 3rd Generation Partnership Project 2 (3GPP2) as part of the CDMA2000 family of standards and employs multiple access techniques such as Code Division Multiple Access (CDMA) to provide broadband Internet access to mobile subscribers. Alternatively, one of WWAN 104 may support Long Term Evolution (LTE), which is a project within the 3GPP2 to improve the Universal Mobile Telecommunications System (UMTS) mobile phone standard based primarily on a Wideband CDMA (W-CDMA) air interface. One of WWAN 104 may also support the WiMAX standard being developed by the WiMAX forum. The actual wireless access protocol employed by a WWAN for any particular telecommunications system will depend on the specific application and the overall design constraints imposed on the system. The various concepts presented throughout this disclosure are equally applicable to any combination of heterogeneous or homogeneous WWANs regardless of the wireless access protocols utilized.

Each WWAN 104 has a number of mobile subscribers. Each subscriber may have a mobile node capable of accessing the Internet 102 directly through the WWAN. These mobile nodes may access the WWAN 104 using a EV-DO, UMB, LTE or some other suitable wireless access protocol.

One or more of these mobile nodes may be configured to create in its vicinity an ad-hoc network based on the same or different wireless access protocol used to access the WWAN 104. By way of example, a mobile node may support a UMB wireless access protocol with a WWAN, while providing an IEEE 802.11 access point for mobile nodes that cannot directly access a WWAN. IEEE 802.11 denotes a set of Wireless Local Access Network (WLAN) standards developed by the IEEE 802.11 committee for short-range communications (e.g., tens of meters to a few hundred meters). Although IEEE 802.11 is a common WLAN wireless access protocol, other suitable protocols may be used.

A mobile node that may be used to provide an access point for another mobile node will be referred to herein as an “ad-hoc service provider” 106. A mobile node that uses an ad-hoc service provider 106 to access a WWAN 104 will be referred to herein as a “mobile client” 108. A mobile node, whether an ad-hoc service provider 106 or a mobile client 108, may be a laptop computer, a mobile telephone, a personal digital assistant (PDA), a mobile digital audio player, a mobile game console, a digital camera, a digital camcorder, a mobile audio device, a mobile video device, a mobile multimedia device, or any other device capable of supporting at least one wireless access protocol.

The ad-hoc service provider 106 may extend its wireless Internet access service to mobile clients 108 that would otherwise not have Internet access. A server 110 may be used as an “exchange” to enable mobile clients 108 to purchase unused bandwidth from ad-hoc service providers 106 to access, for example, the Internet 102 across WWANs 104. In one configuration of a telecommunications system 100, the server 110 charges the mobile clients 108 based on usage. For the occasional user of mobile Internet services, this may be an attractive alternative to the monthly fixed rate wireless access plans. The revenue generated from the usage charges may be allocated to the various entities in the telecommunications system 100 in a way that tends to perpetuate the vitality of the exchange. By way of example, a portion of the revenue may be distributed to the ad-hoc service providers, thus providing a financial incentive for mobile subscribers to become ad-hoc service providers. Another portion of the revenue may be distributed to the WWAN operators to compensate them for the bandwidth that would otherwise go unutilized. Another portion of the revenue may be distributed to the manufacturers of the mobile nodes.

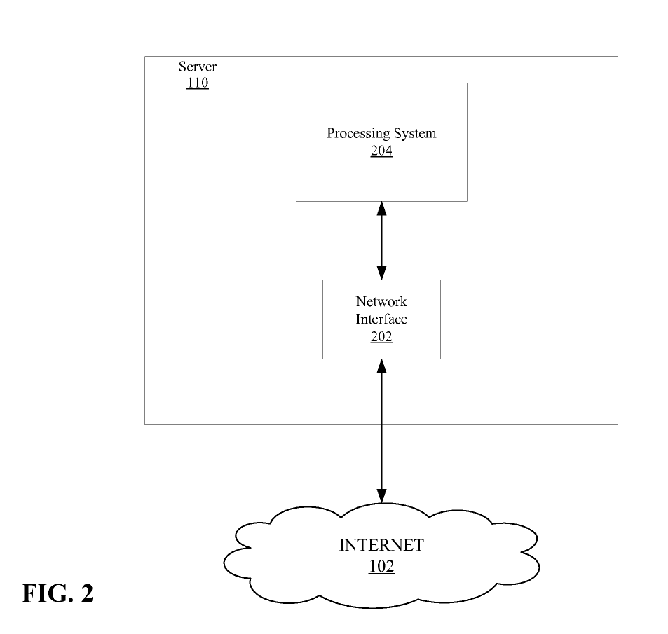

FIG. 2 is illustrates an example of a hardware implementation for a server. The server 110 may be a centralized server or a distributed server. A centralized server may be a dedicated server or integrated into another network-related entity, such as a desktop or laptop computer, mainframe, or other suitable entity. A distributed server may be distributed across multiple servers and/or one or more network-related entities, such as a desktop or laptop computer, mainframe, or some other suitable entity. In at least one configuration, the server may be integrated, either in whole or part, into one or more ad-hoc service providers.

The server 110 is shown with a network interface 202, which may support a wired and/or wireless connection to the Internet 102. The network interface 202 may be used to implement the physical layer by providing the means to transmit data in accordance with the physical and electrical specifications required to interface to the transmission medium. The network interface 202 may also be configured to implement the lower portion of the data link layer by managing access to the transmission medium.

The server 110 is also shown with a processing system 204 that provides various functions, including registration and authentication of the ad-hoc service providers and mobile clients, control session management for the ad-hoc service providers and mobile clients, handoff support between ad-hoc service providers, data tunneling for mobile clients, and various services to mobile clients. The processing system 204 is shown separate from the network interface 202, however, as those skilled in the art will readily appreciate, the network interface 202, or any portion thereof, may be integrated into the processing system 204.

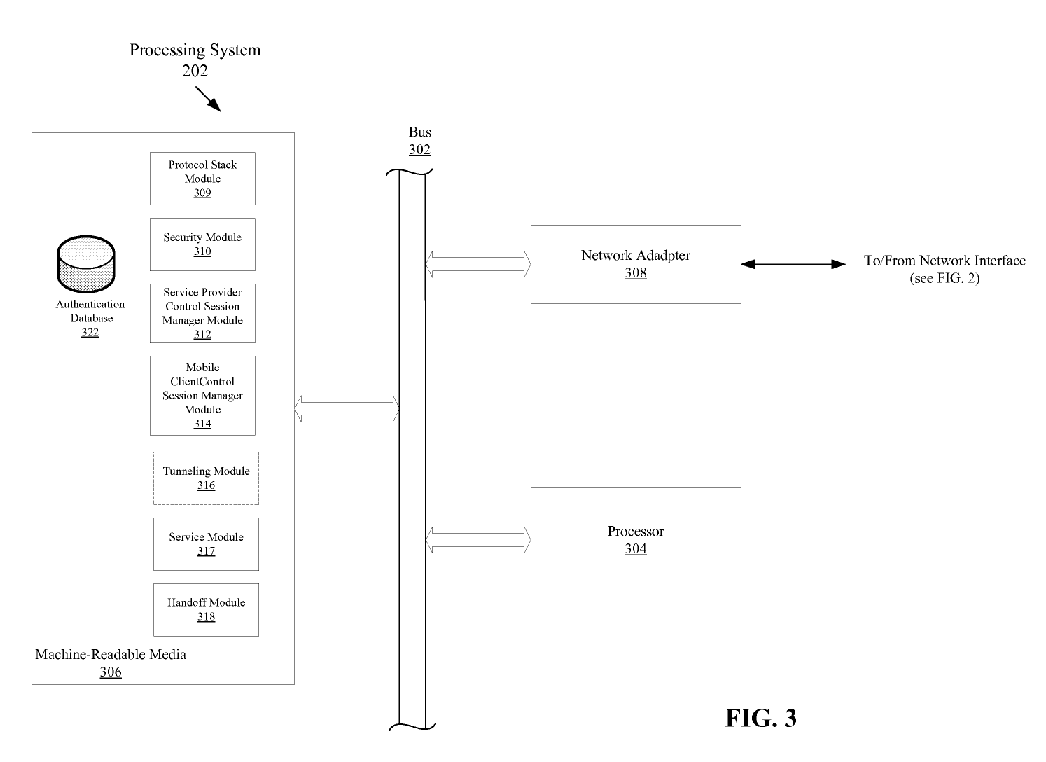

FIG. 3 is a simplified diagram illustrating an example of a hardware implementation for a processing system in a server. In this example, the processing system 204 may be implemented with a bus architecture represented generally by bus 302. The bus 302 may include any number of interconnecting buses and bridges depending on the specific application of the processing system 204 and the overall design constraints. The bus links together various circuits including a processor 304 and machine-readable media 306. The bus 302 may also link various other circuits such as timing sources, peripherals, voltage regulators, power management circuits, and the like, which are well known in the art, and therefore, will not be described any further. A network adapter 308 provides an interface between the network interface 202 (see FIG. 2) and the bus 302.

The processor 304 is responsible for managing the bus and general processing, including the execution of software stored on the machine-readable media 306. The machine-readable media 306 is shown with a number of software modules. Each module includes a set of instructions that when executed by the processor 304 cause the processing system 204 to perform the various functions described below. The software modules include a protocol stack module 309, a security module 310, a service provider control session manager module 312, a mobile client control session manager module 314, a tunneling module 316, a service module 317, and a handoff module 318. A database 320 is also shown for storing information.

The protocol stack module 309 may be used to implement the protocol architecture, or any portion thereof, for the server. In the implementation described thus far, the protocol stack module 309 is responsible for implementing several protocol layers running on top of the data link layer implemented by the network interface 202 (see FIG. 2). By way of example, the protocol stack module 309 may be used to implement the upper portion of the data link layer by providing flow control, acknowledgement, and error recovery. The protocol stack module 309 may also be used to implement the network layer by managing source to destination data packet transfer, as well as the transport layer by providing transparent transfer of data between end users. Although described as part of the processing system, the protocol stack module 309, or any portion thereof, may be implemented by the network adapter 202.

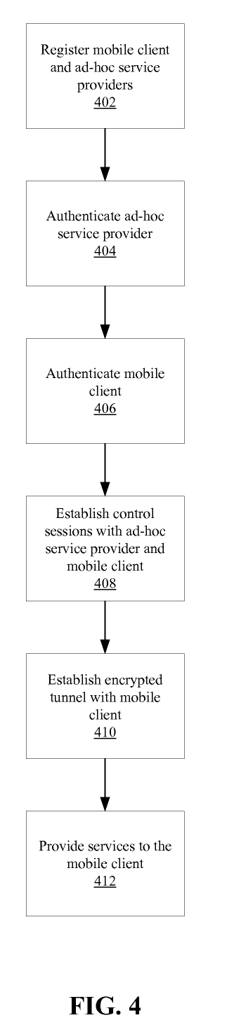

FIG. 4 is a flow diagram illustrating an example of the functionality of the various software modules in the server. An example illustrating the operation of these software modules will now be presented with reference to FIGS. 3 and 4. In step 402, the security module 310 may be used to register mobile clients and ad-hoc service providers either statically (non-mobile) or dynamically (mobile). A server certificate may be supplied to mobile clients or the ad-hoc service providers. This certificate contains the public key of the server signed with the private key of an external certificate authority. The mobile clients and the ad-hoc service providers are provisioned with the public key of the certificate authority, and therefore, are able to verify the signature, and to then use the public key to communicate privately with the server. The security module 310 may allow a mobile client to register by setting up a user name and password with payment information. The security module 310 may also allow an ad-hoc service provider to register by setting up a user name and a password. The registration information (i.e., user names and passwords) may be stored in the database 320.

In step 404, the security module 310 may authenticate a registered ad-hoc service provider when the ad-hoc service provider desires to provide a wireless access point to other mobile clients. In this example, the security module 310 sends a certificate to the ad-hoc service provider in response to a request. Upon receipt of the certificate, and after validating the server certificate, the ad-hoc service provider suggests a session key (K_{SP,S}) encrypted with the public key of the server. This is received by the server and provided to the security module 310. The security module 310 then receives from the ad-hoc service provider its username and password encrypted with the session key K_{SP,S}. The security module 310 authenticates the ad-hoc service provider based on the username and password stored in the database 320. Once authenticated, the security module 310 communicates to the ad-hoc service provider confirming that the ad-hoc service provider is now authenticated and may receive service.

In step 406, the security module 310 may be used to authenticate a registered mobile client. Authentication will generally require connectivity over an ad-hoc wireless link between the mobile client and the ad-hoc service provider, but may be performed in some cases directly between the mobile client and the server. Existing connectivity between an ad-hoc service provider and the server is used to establish connectivity between the mobile client and the server. In this example, the mobile client is the supplicant, the ad-hoc service provider is the authenticator, and the server is the authentication server. The mobile client requests a certificate from the server. The ad-hoc service provider forwards this request to the server, receives a certificate from the security module 310, and forwards that certificate to the mobile client. Upon receipt of the certificate, and after validating the server certificate, the mobile client suggests a session key (K_{C,S}) encrypted with the public key of the server. This is received by the server and provided to the security module 310 so that all subsequent messages between the server and the mobile client can be encrypted with the session key K_{C,S}. The security module 310 then receives from the mobile client its username and password encrypted with the session key K_{C,S}. The security module 310 authenticates the mobile client based on the username and password stored in the database 320. Once authenticated, the security module 310 communicates to the ad-hoc service provider and the mobile client that the mobile client is now authenticated and may receive service.

Next, in step 408, the server establishes control sessions with the ad-hoc service provider and the mobile client. The service provider control session manager module 312 establishes and maintains a secure session X_{SP,S} with the ad-hoc service provider using the key K_{SP,S} for encrypted control messages. Similarly, the mobile client control session manager module 314 establishes and maintains a secure session X_{C,S} with the mobile client using the key K_{C,S} for encrypted control messages. A key K_{SP,C} may be generated at the mobile client and communicated to the mobile client control session manager module 314 over the session X_{C,S}. The key K_{SP,C} may then be provided to the ad-hoc service provider over the session X_{SP,S}. This allows a secure session X_{SP,C} to be established and maintained between the mobile client and the ad-hoc service provider using the key K_{SP,C}. In alternative configurations, the key K_{SP,C} may be generated by the security module 304 in the server or the ad-hoc service provider.

The session keys described thus far, K_{SP,S}, K_{C,S} and K_{SP,C}, are exchanged at the application layer. IP-headers and information regarding the message type may be exposed. To prevent any visibility into information flowing over the ad-hoc wireless link between the mobile client and the ad-hoc service provider, securing the transmissions over the wireless link can be performed. The mobile client and the ad-hoc service provider can agree to a data link encryption key WK_{SP,C} for the wireless link. Such a key may be generated at either the mobile client, the ad-hoc service provider, or the security module 310 in the server. Once the mobile client and the ad-hoc service provider agree to using this data link encryption key, all transmissions between them can be communicated using this key.

In step 410, control messages can be exchanged over the secure session X_{C,S}, between the mobile client and the mobile client control session manager module 314 in the server to establish an encrypted tunnel to transport data to the Internet. The tunnel may be, by way of example, an encrypted SSL VPN tunnel. The tunneling module 316 is responsible for the routing all data between the Internet and the mobile client. This is done to ensure that the ad-hoc service provider has no visibility into data associated with the mobile client, and hence ensures the privacy of the mobile client. This tunneling also provides security to the ad-hoc service provider by ensuring that all data associated with the mobile client flows through the server, leaving the responsibility of such mobile client transactions to the server and the mobile client, with the ad-hoc service provider merely serving as a transport to allow data associated with the mobile client to reach the server.

The tunneling module 316 may also provide network address translation to and from the Internet for the mobile client.

The tunneling module 316 is depicted with short-dashed lines to emphasize that it may be located in the server or elsewhere in the telecommunications system. In the latter case, the tunneling module (or tunneling anchor) may be located in any suitable entity or distributed across multiple entities in the telecommunications system. By way of example, the tunneling anchor may be located anywhere on the Internet or within the network operator's infrastructure. Those skilled in the art will be readily able to determine the optimal implementation of the tunneling anchor for any particular application based on the performance requirements, the overall design constraints imposed on the system, and/or other relevant factors.

Once the tunnel is established between the mobile client and the server, the service module 317 may be used to provide various services to the mobile client in step 412. By way of example, the service module 317 may support audio or video services to the mobile client. The service module 317 may also support advertising services to the mobile client.

The handoff module 318 may provide support for a handoff of a mobile client from one ad-hoc service provider to another based on any number of factors. These factors may include, by way of example, the quality of service (QoS) required by the mobile client, the duration of the session required by the mobile client, and the loading, link conditions, and energy level (e.g., battery life) at the ad-hoc service provider.

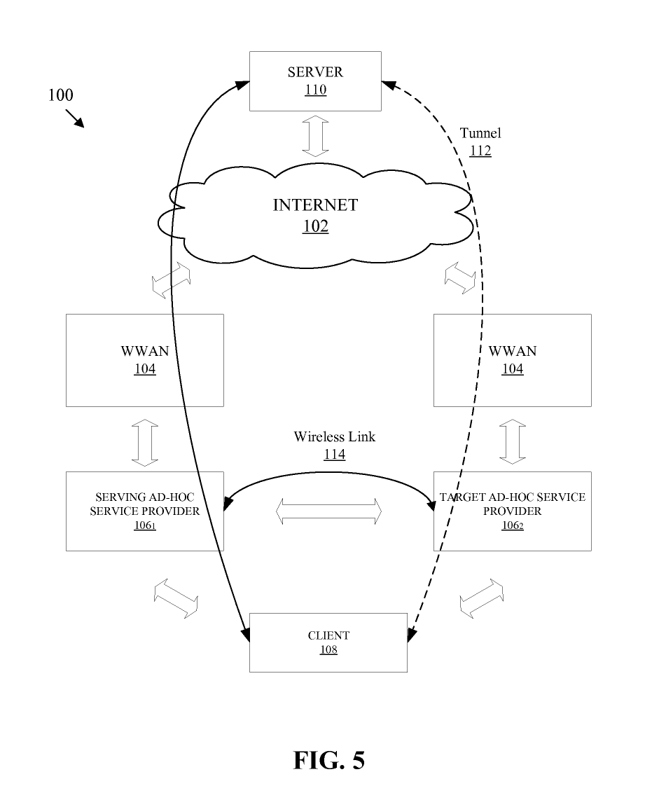

FIG. 5 is a simplified block diagram illustrating an example of a handoff. In this example, the mobile client 108 is being handed off from a “serving ad-hoc service provider” 106₁ to a “target ad-hoc service provider” 106₂. A persistent tunnel 112 between the two ad-hoc service providers 106₁, 106₂ is used to maintain the mobile client's session with the server 110 during handoff. Data packets destined to the client received by the serving ad-hoc service provider 106₁ during handoff may be forwarded to the target ad-hoc service provider 106₂ through the tunnel 112. Data packets received by the serving ad-hoc service provider 106₁ originating from the client during handoff may be sent directly to the tunneling anchor location in tunnel 112. Alternatively, or in addition to, the data packets associated with the client (that may be either be destined to the client or originating from the client) that are received by the serving ad-hoc service provider 106₁ may be forwarded to the target ad-hoc service provider 106₂ directly over a wireless link 114 between the two as shown in FIG. 5, or through another ad-hoc service provider (not shown). The serving ad-hoc service provider 106₁ may stop forwarding received data packets associated with the client during handoff when there are no packets needed for forwarding or when a timer expires at the serving ad-hoc service provider 106₁.

The mobile client 108 may have an JPv4, IPv6, or other suitable address that is used by the server 110 to maintain the session. The address may be provided to the mobile client 108 by the server 110 or one of the ad-hoc service providers 106 in the telecommunications network. Alternatively, the address may be stored on the mobile client 108. In at least one configuration, the address may be a MobilelIP address.

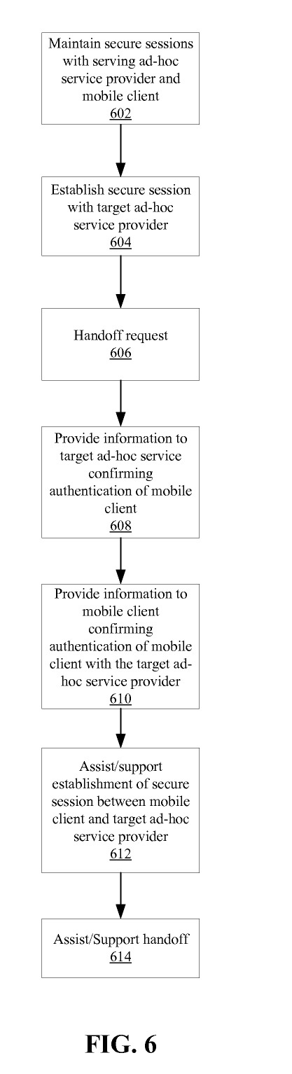

In one configuration of a server, a handoff module 318 is used to manage and coordinate the activities of the other software modules to perform the handoff of the mobile client. FIG. 6 is a flow diagram illustrating an example of the functionality of various software modules in a processing system of a server supporting the handoff. An example illustrating the operation of these software modules will now be presented with reference to FIGS. 3 and 6. In this example, a mobile client connected to a “serving ad-hoc service provider” (SP1) is handed off to a “target ad-hoc service provider” (SP2). Initially, three secure sessions X_{SP1,S}, X_{C,S} and X_{SP1,C} exist using session keys K_{SP1,S}, K_{C,S} and K_{SP1,C}, respectively. In step 602, the service provider control session manager 312 maintains a secure session X_{SP1,S} with the serving ad-hoc service provider using the session key K_{SP1,S}, and the mobile client control session manager 314 maintains a secure session X_{C,S} with the mobile client using the session key K_{C,S}. When the target ad-hoc service provider SP2 becomes available, a secure session X_{SP2,S} may be established by the ad-hoc service control session manager module 312 in step 604 using a session key K_{SP2,s} negotiated between the target ad-hoc service provider SP2 and the security module 310.

A handoff request may be initiated, in step 606, by either the mobile client, the serving ad-hoc service provider SP1, or the handoff module 318 in the server. The service provider control session manager module 312 can provide information to target ad-hoc service provider SP2, in step 608, indicating that the mobile client is authenticated. Over the secure session X_{C,S}, the mobile client may be informed by the mobile client control session manager module 314, in step 610, that it has been authenticated with the target ad-hoc service provider SP2. A session key K_{SP2,C} may be generated by the mobile client, the target ad-hoc service provider SP2, or the security module 310 in the server. The handoff module 318 may be used, in step 612, to assist and/or support the establishment and maintenance of a secure session X_{SP2,C} between the mobile client and the target ad-hoc service provider SP2. In step 614, the handoff module 318 may be used to assist and/or support the handoff. The handoff entails a disassociation by the mobile client with serving ad-hoc service provider SP1 and association with target service provider SP2. The session key K_{SP2,C} may be used for the secure session X_{SP2,C} between the mobile client and the target ad-hoc service provider SP2, which has now become the serving ad-hoc service provider. Information (such as residual packets associated with the mobile client) can be exchanged between the service providers through the server with the assistance of the handoff module 318 for both service providers. A session key K_{SP1,SP2} may be established for secure exchange of messages between the service providers. Alternatively, such exchange of information can occur over a direct wireless link between the service providers if the service providers can reach each other over a local wireless link. It is possible that a multi-hop wireless path between the service providers is used in a wireless mesh network topology if such a path is available. It is possible that some information (such as control flow information) may go through the server with the assistance of the handoff module 318, while other information (such as data flow information) may go over the direct wireless link/path between the service providers.

In one configuration of a server, a quality metric for each ad-hoc service provider may be stored in the database 320. The quality metric reflects the level of service an ad-hoc service provider has provided during previous access sessions with mobile clients. The control session managers 312, 314 may monitor each session between an ad-hoc service provider and a mobile client and update the quality metric associated with the ad-hoc service provider based on one or more factors. The factors may include, but are not limited to, the duration of the access session and the average bandwidth of access to the WWAN provided to the mobile client. Monitored factors may be assigned a value from a range of values for each session. The quality metric for the session may be the sum or average of these values. As an ad-hoc service provider provides more access sessions to mobile clients, the quality metric associated with the ad-hoc service provider may be continually updated by averaging the quality metrics from prior access sessions. This average may be a straight average or it may be weighted to favor more recent access sessions.

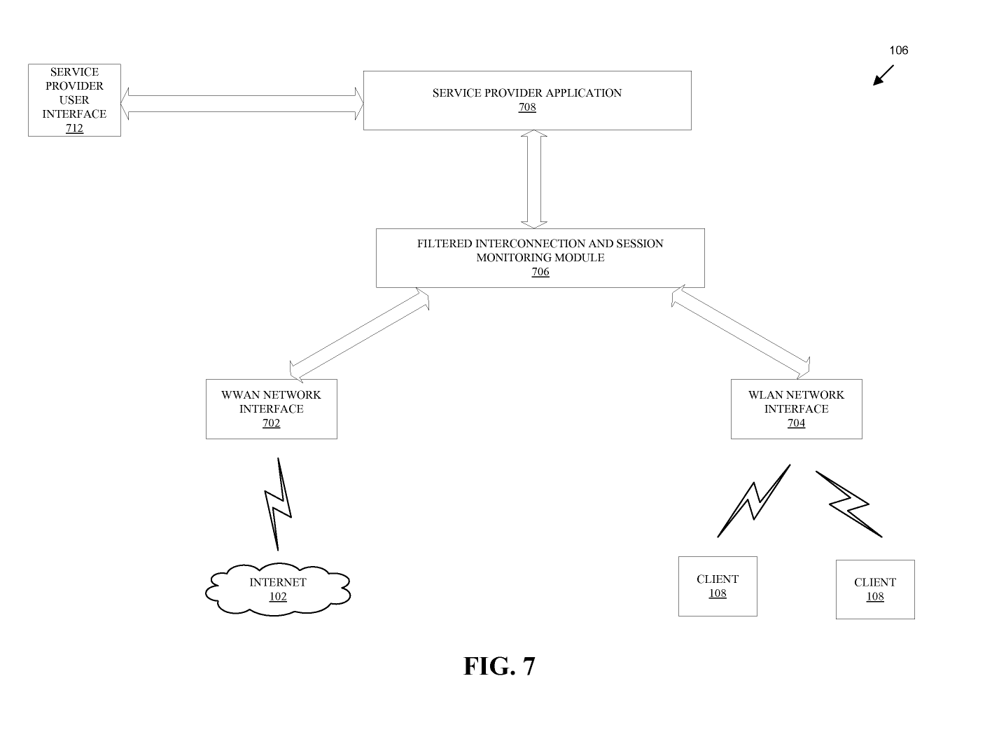

FIG. 7 is a simplified block diagram illustrating an example of the functionality of an ad-hoc service provider. The ad-hoc service provider 106 has the ability to enable interconnection between wireless links over homogeneous or heterogeneous wireless access protocols. This may be achieved with a WWAN network interface 702 that supports a wireless access protocol for a WWAN to the Internet 102, and a WLAN network interface 704 that provides a wireless access point for mobile clients 108. By way of example, the WWAN network interface 702 may include a transceiver function that supports EV-DO for Internet access through a WWAN, and the WLAN network interface 704 may include a transceiver function that provides an 802.11 access point for mobile clients 108. More generally, each of the WWAN and WLAN network interfaces 702, 704 may be configured to implement the physical layer by providing the means to transmit raw data bits in accordance with the physical and electrical specifications required to interface to its respective transmission medium. Each of the WWAN and WLAN network interfaces 702, 704 may also be configured to implement the lower portion of the data link layer by managing access to its respective transmission medium.

The ad-hoc service provider 106 is shown with a filtered interconnection and session monitoring module 706. The module 706 provides filtered processing of content from mobile clients 108 so that the interconnection between the ad-hoc wireless links to the WWAN interface 702 is provided only to mobile clients 108 authenticated and permitted by the server to use the WWAN network. The module 706 also maintains tunneled connectivity between the server and the authenticated mobile clients 108.

The ad-hoc service provider 106 also includes a service provider application 708 that (1) enables the module 706 to provide ad-hoc services to mobile clients 108, and (2) supports WWAN or Internet access to a mobile subscriber or user of the ad-hoc service provider 106. The latter function is supported by a user interface 712 that communicates with the WWAN interface 702 through the module 706 under control of the service provider application 708.

As discussed above, the service provider application 708 enables the module 706 to provide ad-hoc services to mobile clients 108. The service provider application 708 maintains a session with the server to exchange custom messages with the server. In addition, the service provider application 708 also maintains a separate session with each mobile client 108 for exchanging custom messages between the service provider application 708 and the mobile client 108. The service provider application 708 provides information on authenticated and permitted clients to the filtered interconnection and session monitoring module 706. The filtered interconnection and session monitoring module 708 allows content flow for only authenticated and permitted mobile clients 108. The filtered interconnection and session monitoring module 706 also optionally monitors information regarding content flow related to mobile clients 108 such as the amount of content outbound from the mobile clients and inbound to the mobile clients, and regarding WWAN and WLAN network resource utilization and available bandwidths on the wireless channels. The filtered interconnection and session monitoring module 706 can additionally and optionally provide such information to the service provider application 708. The service provider application 708 can optionally act on such information and take appropriate actions such as determining whether to continue maintaining connectivity with the mobile clients 108 and with the server, or whether to continue to provide service.

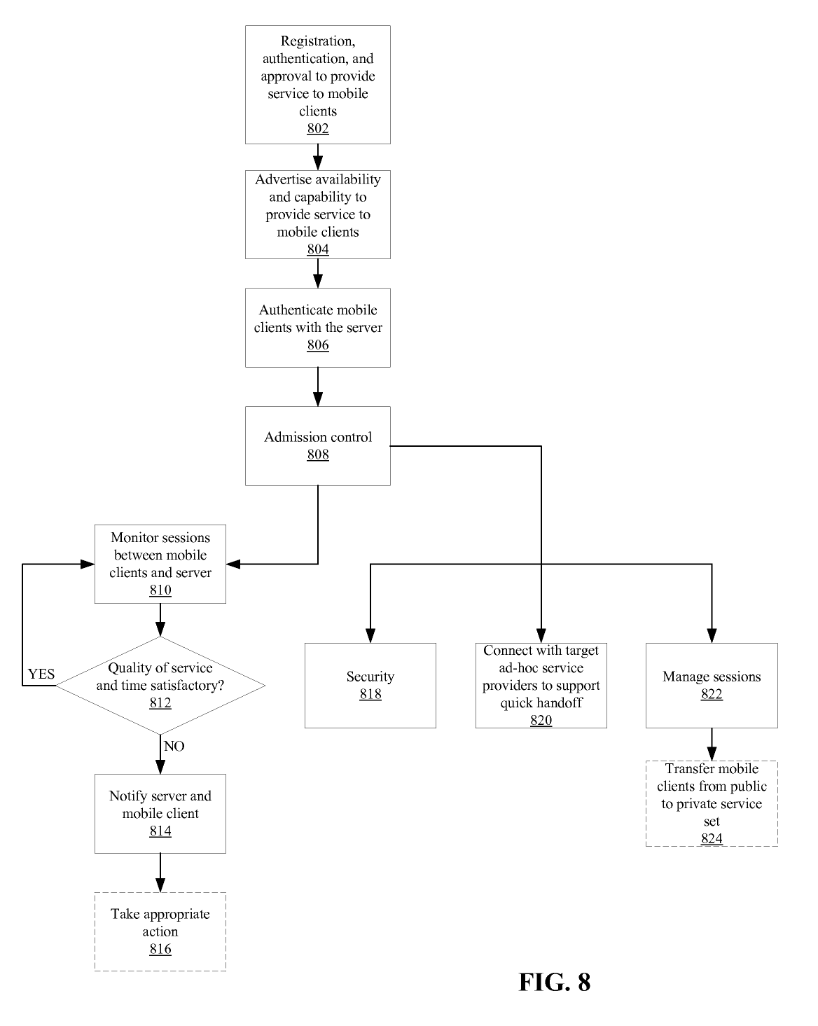

FIG. 8 is a flow diagram illustrating an example of the functionality of the service provider application. Referring to FIGS. 7 and 8, the ad-hoc service provider 106, in step 802, may (1) register with the server, and (2) request authentication and approval to provide services to mobile clients from the server. The server may authenticate the ad-hoc service provider 106 and then determine whether it will grant the ad-hoc service provider's request. As discussed earlier, the request may be denied if the number of ad-hoc service providers in the same geographic location is too great or if the WWAN operator has imposed certain constraints on the ad-hoc service provider 106.

Once the ad-hoc service provider 106 is authenticated and approved to provide service to one or more mobile clients 108, the service provider application 708, in step 804, may provide the functionality required to enable the ad-hoc service provider 106 to advertise its availability to provide access to the WWAN 104. This may be achieved by assembling and broadcasting service information to mobile clients 108 within the range of coverage. The service information may include parameters for accessing the WLAN established with the ad-hoc service provider 106 as a wireless access point as well as attributes of access to the WWAN 104 offered by the ad-hoc service provider 106. The parameters of access to the WLAN may include a Service Set IDentifier (SSID) for a public service set associated with the ad-hoc service provider 106, supported data rates, data security mechanisms, as well as other parameters used by the mobile client 108 to associate and establish a wireless link with the ad-hoc service provider 106. The SSID may be set to include characters identifying the ad-hoc service provider 106 as a mobile node offering access to a WWAN 104.

The attributes of access to the WWAN 104 offered by the ad-hoc service provider 106 may include information to enable a mobile client 108 to determine whether the ad-hoc service provider 106 is providing sufficient access to the WWAN 104 to meet the needs of the mobile client 108 and to select the ad-hoc service provider 106 if acceptable to the mobile client 108. The attributes of access may include the previously discussed quality metric associated with the ad-hoc service provider 106, fee rates of access to the WWAN 104, and/or one or more quality of service parameters. The quality of service parameters include, but are not limited to, an expected data rate of access to the WWAN 104, an expected duration of access to the WWAN 104, a latency of access to the WWAN 104, a frequency of access to the WWAN 104, and an amount of transferred data with respect to the WWAN 104.

The expected duration of access to the WWAN 104 is a user-specified period of time reflecting an amount of time a mobile subscriber anticipates making an ad-hoc service provider 106 available at a particular geographic location such as an airport terminal, hotel lobby, sports venue, etc. The expected duration of access may be communicated to the server when the ad-hoc service provider 106 is authenticated and approved by the server to provide access to the WWAN 104.

The expected data rate of access to the WWAN 104 via the wireless link between the ad-hoc service provider 106 and the WWAN 104 may vary depending on the wireless access protocol used within the WWAN 104, the signal strength of the wireless link between the ad-hoc service provider 106 and the WWAN 104, and the amount of concurrent data traffic within the WWAN 104. The ad-hoc service provider 106 may be configured to monitor the average data rate of access to the WWAN 104 available to the ad-hoc service provider 106. Based on this average data rate, an expected average data rate of access to the WWAN 104 available to a mobile client 108 through the ad-hoc service provider 106 is determined.

The expected average data rate of access to the WWAN 104 may be set as a percentage of the total available data rate available to the ad-hoc service provider 106 or it may be set to a user-specified amount by the mobile subscriber offering access through the ad-hoc service provider 106. In an alternative configuration, the server may set the expected average data rate when the ad-hoc service provider 106 is authenticated and approved to provide service. The server may set the expected average data rate using information received from the ad-hoc service provider 106 when approval was requested and based on an agreement reached with the mobile subscriber regarding the level of service to be provided.

Both the expected duration of access and the expected data rate of access to the WWAN 104 are dynamic attributes. By way of example, the expected duration of access to the WWAN 104 may be set when the ad-hoc service provider 106 is authenticated and approved to provide service with the server. The expected duration will decrease to reflect the amount of time the ad-hoc service provider 106 has been available to provide access to a mobile client 108 since the ad-hoc service provider 106 was authenticated and approved by the server 110. Optionally, the mobile subscriber may update the amount of time the ad-hoc service provider 106 will be available to provide access. The ad-hoc service provider 106 may be required to re-authenticate and request approval from the server to continue providing service once the initially set period to time expires.

The expected data rate of access to the WWAN 104 also may change while the ad-hoc service provider 106 is available to provide access. For example, the overall data rate available to the ad-hoc service provider 106 may vary due to changes in traffic on the WWAN 104. Similarly, the expected data rate of access may be partially utilized by a first mobile client 108 when subsequent mobile clients 108 seek access to the WWAN 104. The expected data rate of access to the WWAN 104 may be modified to take these changes into account.

The latency and frequency of access to the WWAN 104 refer to operating details of the access offered by the ad-hoc service provider 106 to the mobile client 108. For example, the latency and frequency of access may refer to the latency of packet access, the frequency of packet transmission, the duration of packet transmission, the packet length, etc. available to the mobile client during a given session. Varying these parameters varies the priority associated with associated access sessions available to mobile clients 108. Accordingly, a mobile client 108 may select access offered by an ad-hoc service provider that provides access priority to the WWAN 104 suitable for the applications being used by the mobile client 108.

The amount of transferred data refers to an amount of data transmitted and/or received by a mobile client 108 when accessing the WWAN 104 during an access session. The amount of transferred data may indicate the maximum amount of data that a mobile client 108 is permitted to receive and/or transmit via WWAN 104 in a single access session. The amount of transferred data may refer to bytes per session or bytes per a specified period of time.

The fee rate of access to the WWAN 104 is the cost per unit time incurred by a mobile client 108 when accessing the WWAN 104 via a WLAN established by the ad-hoc service provider 106. The fee rate may include a range of fee rates covering different periods of time. The fee rate also may include a range of fees associated with different combinations of quality of service parameters discussed above. The fee rate for access to the WWAN 104 may be provided by the server to the ad-hoc service provider 106 at the time of authentication and approval for providing access to the WWAN 104. Alternatively, the ad-hoc service provider 106 may set or adjust the fee rate independent of the server.

The service provider application 708 may be used to receive one or more of the foregoing attributes of access to the WWAN 104 from the server. These attributes may include the quality metric associated with the ad-hoc service provider 106 and a fee rate of access to the WWAN 104.

The service provider application 808 may be used to dynamically update one or more attributes of access to the WWAN 104 offered by the ad-hoc service provider 106 based on the status of the ad-hoc service provider 106. As discussed above, such attributes may include the expected duration of access and the expected data rate of access to the WWAN 104.

The service provider application 708 may be used to assemble the service information discussed above into a format suitable for broadcasting to one or more mobile clients 108. By way of example, a driver for the WLAN network interface 704 may be modified to assemble the parameters and attributes into a beacon frame that is subsequently transmitted. Beacon frames are a common feature in wireless access protocols to notify mobile nodes within a specified range of the availability of a wireless network access point. A beacon frame may include fields whose contents are dictated by the wireless access protocol as well as fields that are vender-specific or user-specific to allow for custom applications. The parameters of access to the WLAN may be automatically incorporated into fields of the beacon frame specified by the wireless access protocol used within the WLAN. The service provider application 708 may be configured to incorporate one or more of the attributes of access to the WWAN 104 into the user-specified fields.

The service provider application 708 also may be configured to incorporate one or more attributes of access to the WWAN 104 into a parameter of access to the WLAN. By way of example, the SSID of the WLAN may not use all of the available bytes of the beacon frame. The service provider application 708 may be configured to incorporate one or more attributes of access to the WWAN 104 into the SSID of the WLAN. The number of attributes that may be incorporated into the SSID will vary depending on the data size of the SSID and the data size of the attributes.

Once construction of the beacon frame is complete, the WLAN network interface 702 broadcasts the beacon frame to mobile clients 108 within range of the transceiver.

Interested mobile clients 108 may associate with the public service set identified by the SSID to access the ad-hoc service provider 106. The service provider application 708 may then authenticate the mobile clients 108 with the server in step 806. During the authentication of a mobile client 108, the service provider application 708 may use an unsecured wireless link.

In step 808, the service provider application 708 performs various admission control functions. More specifically, the service provider application 708 determines whether it can support a mobile client 108 before allowing the mobile client 108 to access a network. Resource intelligence that estimates the drain on the battery power and other processing resources that would occur by accepting a mobile client 108 may assist in determining whether the service provider application 708 should consider supporting a new mobile client 108 or accepting a handoff of that mobile client 108 from another ad-hoc service provider.

The service provider application 708 may admit mobile clients 108 and provide them with a certain quality of service guarantee, such as an expected average bandwidth during a session. In step 810, the service provider application may monitor the sessions. Average throughputs provided to each mobile client 108 over a time window may be monitored. The service provider application 708 may monitor the throughputs for all flows going through it to ensure that resource utilization by the mobile clients 108 is below a certain threshold, and that it is meeting the quality of service requirement that it has agreed to provide to the mobile clients 108 during the establishment of the session.

If the service provider application 708 determines that it is unable to provide the mobile client 108 with access to the network for the agreed upon time period with the quality of service required, in step 812, then it may notify both the server and the mobile client 108 regarding its unavailability in step 814. This may occur due to energy constraints (e.g., a low battery), or other unforeseen events. The service provider application 708 may then take one or more of the following exemplary actions, in step 816: (a) not admit any new mobile clients 108 into the wireless network; (b) initiate a handoff of some or all of the existing mobile clients 108 of the ad-hoc service provider 106 to other ad-hoc service providers 106; (c) terminate the ad-hoc service provider's service being provided to some or all of the existing mobile clients 108 (by way of illustration, shutting down the ad-hoc service provider 106 will terminate the service being provided to all of the existing mobile clients 108); (d) alter one or more attributes of the ad-hoc service provider's service such as a data rate of the service or the duration of the service; (e) perform some other action(s); (f) perform no action (as illustrated by the short-dashed lines depicting the block in step 816); or (g) notify some or all of the mobile clients 108 and the server an action that the ad-hoc service provider 106 plans to take, where the action can be one or more of the actions described in (a)-(f) of this paragraph.

The service provider application 708 may take a different action with respect to each of the existing mobile clients 108 and the server, or notify a different action to each of the existing mobile clients 108 and the server. Alternatively, the service provider application 708 may take the same action with respect to each or some of the existing mobile clients 108 and the server, or notify the same action to each or some of the existing mobile clients 108 and the server. By way of illustration, as for the actions described in (d), the service provider application 708 may alter the data rate of its service provided to one or more of the existing mobile clients 108. In addition or alternatively, the service provider application 708 may alter the duration of the service provided to one or more of the existing mobile clients 108. Each mobile client 108 (or some mobile clients) may have the same or different data rates, and the service provider application 708 may change the data rate(s) the same way or differently for each of the mobile clients 108 (or for some of the mobile clients). Furthermore, each mobile client 108 (or some mobile clients) may have the same or different duration of service, and the service provider application 708 may change the duration the same way or differently for each of the mobile clients 108 (or for some of the mobile clients).

In step 818, the service provider application 708 may provide a certain level of security to the wireless access point by routing content through the filtered interconnection and session monitoring module 806 without being able to decipher the content. Similarly, the service provider application 708 may be configured to ensure content routed between the user interface 710 and the WWAN 104 via the module 706 cannot be deciphered by mobile clients 108. The service provider application 708 may use any suitable encryption technology to implement this functionality.

In step 820, the service provider application 708 may also dedicate processing resources to maintain a wireless link or limited session with mobile clients 108 served by other ad-hoc service providers. This may facilitate the handoff of mobile clients 108 to the ad-hoc service provider 106.

In step 822, the service provider application 708 may manage the mobile client 108 generally, and the session specifically. The session may be managed through the user interface 712. Alternatively, the service provider application 708 may support a seamless operation mode with processing resources being dedicated to servicing mobile clients 108. In this way, the mobile client 108 is managed in a way that is transparent to the mobile subscriber. The seamless operation mode may be desired where the mobile subscriber does not want to be managing mobile clients 108, but would like to continue generating revenue by sharing bandwidth with mobile clients 108.

In step 824, the service provider application 708 may transfer an authenticated mobile client 108 associated with the public service set to a private service set associated with the ad-hoc service provider 106. Unlike the public service set, the identification and association parameters of the private service set are not openly broadcast to all mobile clients 108 in the vicinity of the ad-hoc service provider 106. To transfer an authenticated mobile client 108 to the private service set, the service provider application 708 may package the private service set identifier and association parameters and securely transmit them directly to the authenticated mobile client 108 using WLAN network interface 704. The service provider application 708 may secure the transmission by using a session key created for a secure link between the authenticated mobile client 108 and the ad-hoc service provider 106. The session key may be created by mobile client 108, the ad-hoc service provider 106 (or service provider application 808) or the server and exchanged with the mobile client 108 and the ad-hoc service provider 106 during the mobile client 108 authentication process. Using the private SSID and association parameters, the authenticated mobile client 108 may disassociate from the public service set and associate with the private service set. Since the authenticated mobile client 108 has already been authenticated for the ad-hoc service provider 106, authentication with the server may not be repeated.

In addition to being associated with a service set separate from the public service set, which is accessible by non-authenticated mobile clients 108, the private service set may use additional security mechanisms such as data link layer encryption algorithms for securing data communication within the private service set.

Authenticated mobile clients 108 may be transferred by the service provider application 708 from the public service set to the private service set in response to one or more transfer events. Possible transfer events may include, but are not limited to, the authentication of the mobile client 108 with the server, the lapse of a set period of time since the mobile client was authenticated with the server, and the disabling of the public service set, which will be described below. The set period of time may be configured by an administrator via the server or the mobile subscriber may set the period of time directly at the ad-hoc service provider via the user interface 712.

The service provider application 708 may be configured to disable the public service set in response to a capacity event. Capacity events may include, but are not limited to, an available data rate of access to the WWAN 104 dropping below a specified data rate and an authenticated number of mobile clients 108 associated with the ad-hoc service provider 106 exceeding a specified number.

The service provider application 708 may disable the public service set by disabling the broadcast of the public SS1D and association parameters. The service provider application 708 also may be configured to deny any further associations with the public service set or stop authentication of any mobile clients 108 associated with the public service set.

In the event that one or more authenticated mobile clients 108 are associated with the public service set when a capacity event occurs, the service provider application 708 may be configured to transfer each of the authenticated mobile clients 108 to the private service set. Alternatively, the service provider application 708 may terminate the session with each of the authenticated mobile clients 108 when a capacity event occurs.

The service provider application 708 may be configured to dynamically allocate resources committed to the public service set and the private service set when each service set includes at least one associated mobile client 108. The service provider application 708 may alternatively processing data traffic from each service set. The amount of time allocated to a particular service set by the service provider application 708 may be based on the number of mobile clients 108 associated with each service set. This allocation may be directly proportional to the numbers in each set or may be weighted to allocate more time to the mobile clients 108 associated with the private service set. In addition to time, the service provider application 808 may allocate other resources such as available hardware resources or priority processing resources between the two service sets.

In at least one configuration of an ad-hoc service provider, a processing system may be used to implement the filtered interconnection and session monitoring module 706, the service provider application 708, and the service provider user interface 712. The WWAN interface 702 and WLAN interface 704 may be separate from the processing system, or alternatively, may be integrated, either in part or whole, into the processing system.

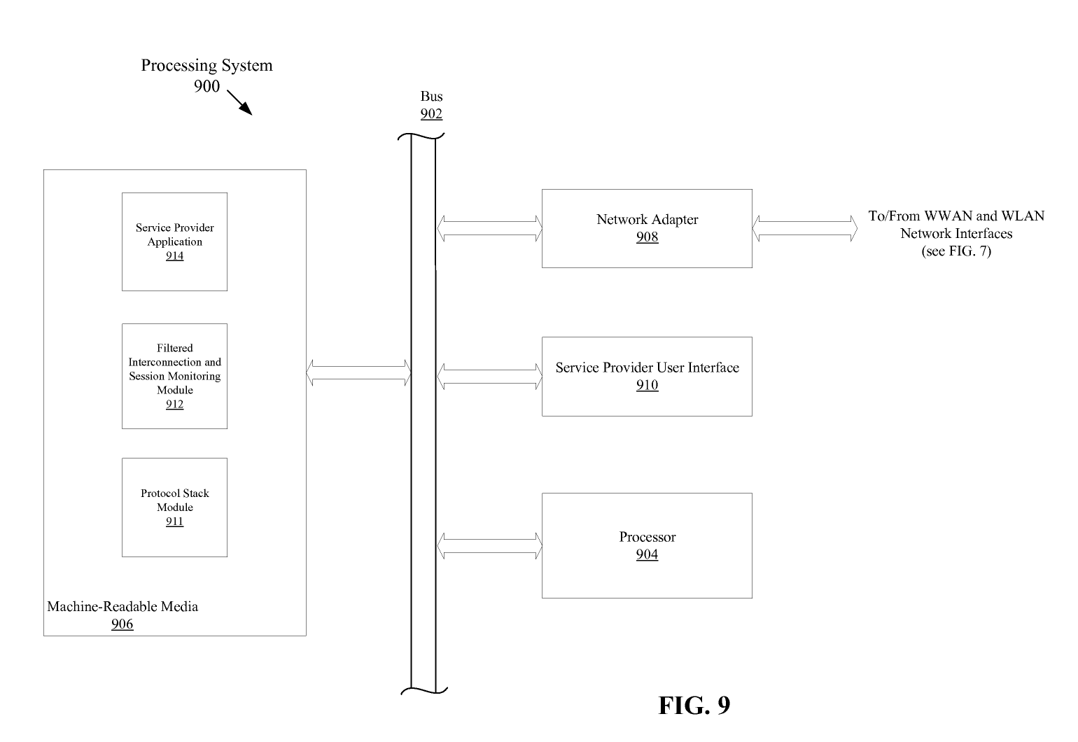

FIG. 9 is a simplified diagram illustrating an example of a hardware configuration for a processing system in an ad-hoc service provider. In this example, the processing system 900 may be implemented with a similar architecture to that described earlier in connection with the server 110 (see FIG. 3). More specifically, the processing system 900 may include a bus 902 comprising any number of interconnecting buses and bridges to link together a processor 904, machine-readable media 906, a service provider user interface 910, and various other circuits. A network adapter 908 provides an interface between the WWAN and WLAN network interfaces 702, 704 (see FIG. 7) and the bus 902.

The processor 904 is responsible for managing the bus and general processing, including the execution of software stored on the machine-readable media 906. The machine-readable media 906 is shown with a number of software modules. The software modules include instructions that when executed by the processor 904 cause the processing system to perform various functions.

A protocol stack module 911 may be used to implement the protocol architecture, or any portion thereof, for the ad-hoc service provider. In the implementation described thus far, the protocol stack module 911 is responsible for implementing several protocol layers running on top of the data link layers implemented by the WWAN and WLAN network interfaces 702, 704 (see FIG. 7). By way of example, the protocol stack module 911 may be used to implement the upper portion of the data link layer by providing flow control, acknowledgement, and error recovery. The protocol stack module 911 may also be used to implement the network layer by managing source to destination data packet transfer, as well as the transport layer by providing transparent transfer of data between end users. Although described as part of the processing system, the protocol stack module 911, or any portion thereof, may be implemented by the WWAN and WLAN network adapters 702, 704.

The machine-readable media 906 is also shown with a filtered interconnection and session monitoring module 912 and service provider application 914. These software modules, when executed by the processor 904, cause the processing system to carry out the various functions described above for each module in connection with FIGS. 7 and 8.

The user interface 910 may include a keypad, display, speaker, microphone, joystick, and/or any other combination user interface devices that enable a mobile subscriber or user to access the WWAN or the Internet 102.

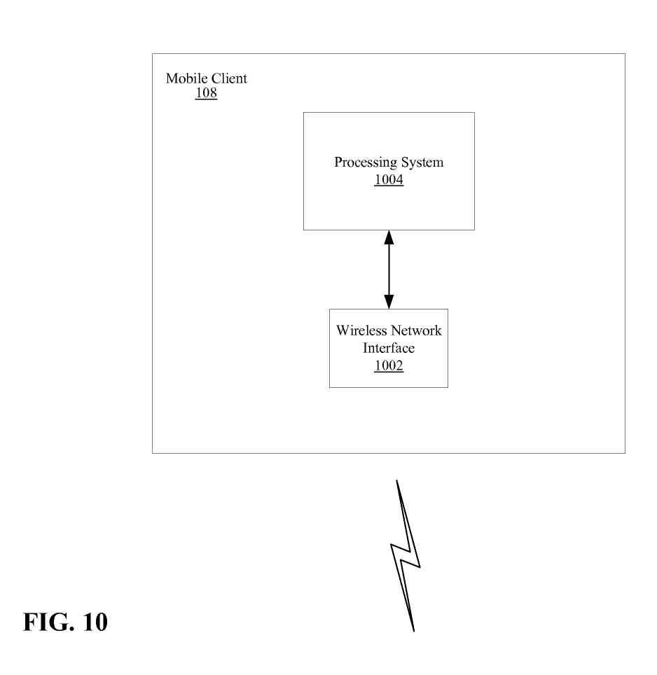

FIG. 10 is illustrates an example of a hardware implementation for a mobile client. The mobile client 108 is shown with a wireless network interface 1002. Similar to the functionality of the network interfaces in the server and ad-hoc service provider, the network interface 1002 in the mobile client 108 may be used to implement the physical layer by providing the means to transmit data in accordance with the physical and electrical specifications required to interface to the wireless transmission medium. The network interface 1002 may also be configured to implement the lower portion of the data link layer by managing access to the transmission medium.

If the bandwidth needs of a mobile client 108 are greater than the capabilities of the available ad-hoc service providers 106, then the mobile client 108 may access multiple ad-hoc service providers 106 simultaneously. A mobile client 108 with multiple network interfaces could potentially access multiple ad-hoc service providers simultaneously using a different transceiver function for each ad-hoc service provider 106. If the same wireless access protocol can be used to access multiple ad-hoc service providers 106, then a single network interface with multiple channels may be used. If the mobile client 108 has only a single network interface, or alternatively, only one network interface is available, then it may distribute the time that it spends accessing each ad-hoc service provider.

The mobile client 108 is also shown with a processing system 1004 that provides various functions, including registration and authentication of the mobile client with the server, searching for ad-hoc service providers, control session management, handoffs between multiple ad-hoc service providers, data tunneling, and services. The processing system 1004 is shown separate from the network interface 1002, however, as those skilled in the art will readily appreciate, the network interface 1002, or any portion thereof, may be integrated into the processing system 1004.

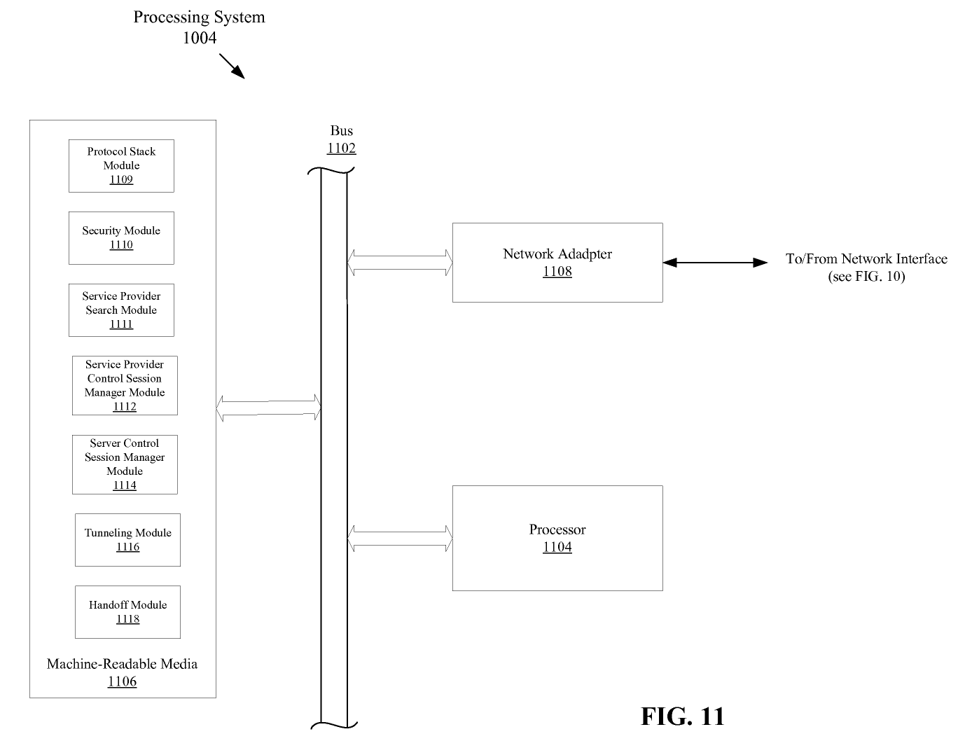

FIG. 11 is illustrates an example of a hardware implementation for a processing system in a mobile client. The functionality of the processing system 1004 may also be implemented in a similar manner to the processing systems in the server and the ad-hoc service provider. More specifically, the processing system 1004 may be implemented with a bus architecture represented generally by bus 1102. The bus 1102 may include any number of interconnecting buses and bridges depending on the specific application of the processing system 1104 and the overall design constraints. The bus links together various circuits including a processor 1104 and machine-readable media 1106. The bus 1102 may also link various other circuits such as timing sources, peripherals, voltage regulators, power management circuits, and the like, which are well known in the art, and therefore, will not be described any further. A network adapter 1108 provides an interface between the network interface 1102 (see FIG. 10) and the bus 1102.

The processor 1104 is responsible for managing the bus and general processing, including the execution of software stored on the machine-readable media 1106. The machine-readable media 1106 is shown with a number of software modules. Each module includes a set of instructions that when executed by the processor 1104 cause the processing system 1004 to perform the various functions described below. The software modules include a protocol stack module 1109, a security module 1110, a service provider search module 1111, a service provider control session management module 1112, a server control session management module 1114, a tunneling module 1116, and a handoff module 1118.

The protocol stack module 1109 may be used to implement the protocol architecture, or any portion thereof, for the mobile client 108. In the implementation described thus far, the protocol stack module 1109 is responsible for implementing several protocol layers running on top of the data link layer implemented by the network interface 1002 (see FIG. 10). By way of example, the protocol stack module 1109 may be used to implement the upper portion of the data link layer by providing flow control, acknowledgement, and error recovery. The protocol stack module 1109 may also be used to implement the network layer by managing source to destination data packet transfer, as well as the transport layer by providing transparent transfer of data between end users. Although described as part of the processing system, the protocol stack module 1109, or any portion thereof, may be implemented by the network adapter 1002.

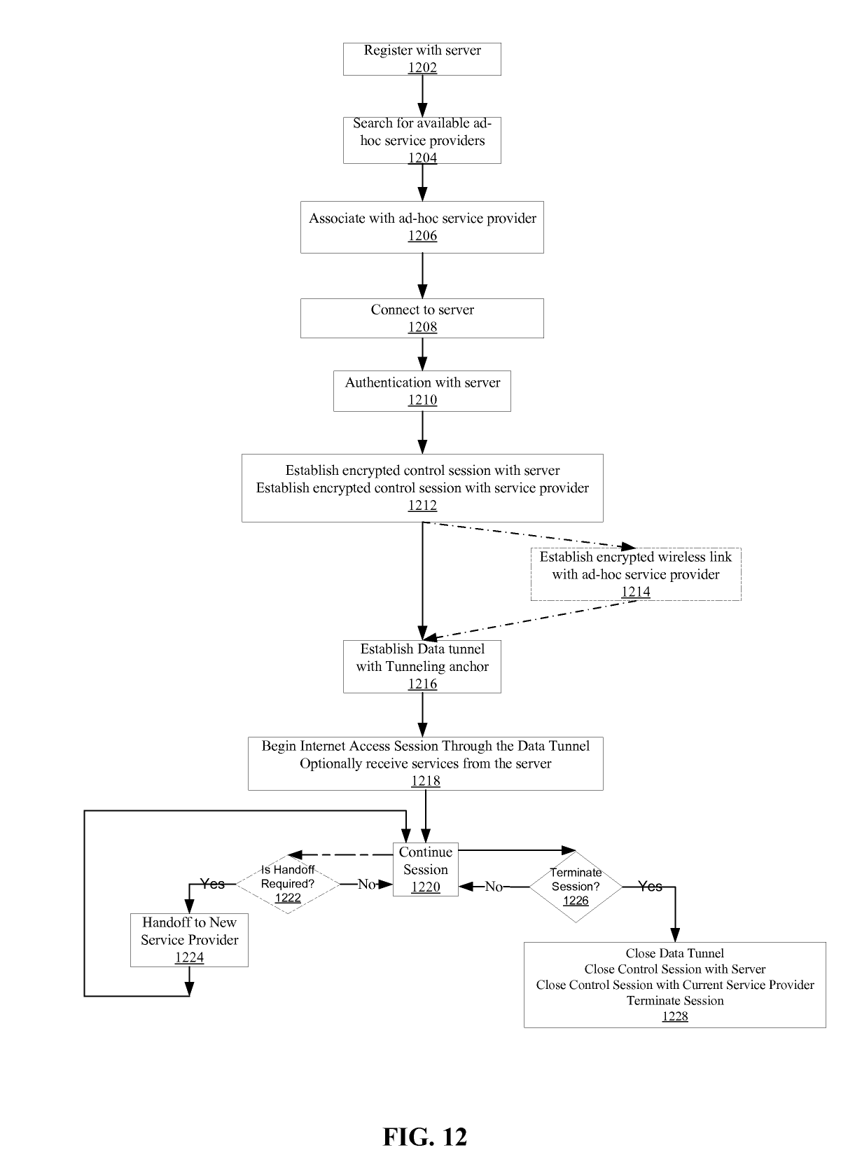

FIG. 12 is a flow diagram illustrating an example of the functionality of the various software modules in the mobile client. An example illustrating the operation of these software modules will now be presented with reference to FIGS. 11 and 12. In this example, the process begins with the registration of the mobile client with the server in step 1202. As described in greater detail earlier in connection with the server, a server certificate may be supplied to the mobile client. This certificate contains the public key of the server signed with the private key of an external certificate authority. The mobile client is provisioned with the public key of the certificate authority, and therefore, is able to verify the signature and to then use the public key to communicate privately with the server. The mobile client may register with the server to set up a user name and password with payment information.

Once registered, the mobile client may use the service provider search module 1111 to search for an ad-hoc service provider that it can use to connect to the Internet. The search for ad-hoc service providers is depicted in step 1204. When the service provider search module 1111 detects the presence of one or more ad-hoc service providers, the service provider control session manager module 1112 associates, in step 1206, with an ad-hoc service provider based on parameters such as the quality metric of the ad-hoc service provider, fee rates or the cost of the service advertised, and/or various quality of service parameters. Quality of service parameters may include, by way of example, expected data rate of access to the WWAN, expected duration of access to the WWAN, latency of access to the WWAN, frequency of access to the WWAN, and the amount of data that the mobile client is permitted to transfer through the WWAN. The mobile client can obtain such information from the ad-hoc service provider beacons, with static information for the session (such as the quality metric) in SSID names, and dynamically changing information in vendor-specific fields in an ad-hoc service provider's beacon. Alternatively, the mobile client can obtain such information by connecting to the ad-hoc service provider and obtaining a custom message from the ad-hoc service provider. Additionally, the mobile client can connect through one ad-hoc service provider, and request information from the server about all ad-hoc service providers in its vicinity. The mobile client may get an IP address from a Dynamic Host Control Protocol (DHCP) client at the ad-hoc service provider or the server, or it may have its own MobileIP or IPv6 address or it may be loaned a MobileIP address or IPv6 by the server.

Once the mobile client associates with an ad-hoc service provider, the server control session manager module 1114 may be used to connect to the server in step 1208. The security module 1110 may use this connection, in step 1210, for authentication with the server. The authentication process supported by the security module 1110 will generally be through the ad-hoc service provider, but may be performed in some cases directly between the mobile client and the server. In either case, the security module 1110 validates a certificate from the server as described in more detail earlier. After validating the server certificate, the security module 1110 suggests a session key (K_{C,S}) encrypted with the public key of the server. The security module 1110 then provides its username and password encrypted with the session key K_{C,S} to the server for authentication.

Once the mobile client is authenticated, encrypted control sessions with the server and ad-hoc service provider may be established in step 1212. The server control session manager module 1114 establishes and maintains a secure session X_{C,S} between the mobile client and the server using the key K_{C,S}. The service provider control session manager 1112 may be used to provide a key K_{SP,C} to the ad-hoc service provider. This allows a secure session X_{SP,C} to be established and maintained between the mobile client and the ad-hoc service provider using the key K_{SP,C}. In alternative configurations, the key K_{SP,C} may be generated by the server or the ad-hoc service provider.

In step 1214, an encrypted wireless link may be optionally established and maintained between the mobile client and the ad-hoc service provider. The security module 1110 and the ad-hoc service provider can agree to a data link encryption key WK_{SP,C} for the wireless link. Such a key may be generated by the security module 1110, or alternatively, the ad-hoc service provider or the server. Once the security module 1110 and the ad-hoc service provider agree to a data link encryption key, all transmissions between mobile client and the ad-hoc service provider can be communicated using this key. Since control sessions between the client and the server, and the client and the service provider are encrypted, and the data tunnel is encrypted, step 1214 may be considered optional. However, to secure and protect the information in lower layer headers from being sniffed by intruders on the wireless link between the client and the service provider, it would be useful to encrypt this wireless link as well in step 1214. In certain implementations, step 1214 may also be executed between steps 1206 and 1208.

In step 1216, information can be exchanged over the secure session X_{C,S}, between the server control session manager module 1110 and the server to establish an encrypted data tunnel to transport data to the Internet through a tunneling anchor. The tunneling anchor may be located at the server. Alternatively, the tunneling anchor may be located at some other network-related entity in the telecommunications system such as within the network infrastructure associated with a wireless carrier or network operator, or may be anywhere on the internet as specified by the server.

Once the data tunnel is established between the mobile client and the tunneling anchor, the mobile client accesses the internet through the tunneling anchor. Data that travels between the mobile client and a location on the Internet is tunneled through the tunneling anchor, with the support of the tunneling module 1116 at the location of the tunneling anchor. Various optional services by the server may be additionally provided to the mobile client in step 1218. By way of example, the mobile client may receive audio, video, advertising, and/or other multimedia content from the server.

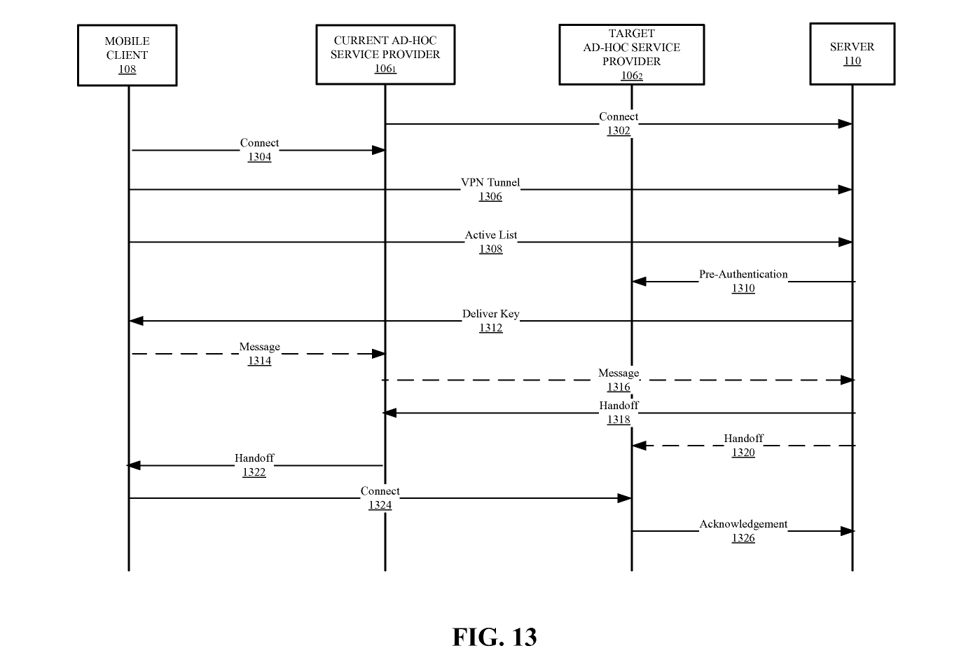

Step 1220 maintains the established control sessions and the data tunnel session at the client. It may periodically check if a handoff is required. Checking for handoff is accomplished in the module 1222 based on parameters such as the link quality associated with the client and the service provider, and/or the effective throughput as perceived by the client, and/or received information at the client related to other available service providers, and/or control message information from the server or the service provider requesting a handoff. If a handoff is not required, the session continues. If a handoff is required, then module 1224 attempts and establishes connectivity with a new service provider. FIG. 13 presents a call flow diagram that is used for handoff. Step 1220 may also periodically check if the session needs to be terminated. Checking for termination is performed in module 1226. This could depend on control messages from the server or the service provider, or the battery-level on the client device, or other constraints associated with the client-device or associated with the user of the client-device such as a need from the user to terminate the session. If termination is not required, then the session continues. If termination is required, a graceful termination is attempted in step 1228 by closing down the data tunnel, terminating the control session with the server, terminating the control session with the service provider, and then terminating any other applications associated with the internet access session. It is possible that a graceful termination may not be possible in certain circumstances associated with the client. In such a case, the data tunnel session at the tunneling anchor, and the control sessions at the server and service provider may time out and the respective sessions with the client may be terminated due to lack of activity and/or lack of connectivity with the client.

The service provider search module 1111 may also be used listen for other ad-hoc service providers and measure the signal strength of the ad-hoc service providers it can hear. The service provider search module 1111 uses these measurements to create an active list. The active list is a list of ad-hoc service providers that can provide service to the mobile client. The service provider search module 1111 will continue to measure the signal strength of other ad-hoc service providers and may add or remove ad-hoc service providers from the active list as the configuration of the ad-hoc network changes.

One function of the active set is to allow the mobile client 108 to quickly switch between ad-hoc service providers 106 while maintaining the current session with the server. The handoff module 1118 may be used to manage and coordinate the activities of other software modules to perform a handoff based on any number of factors. These factors may include, by way of example, the inability of the ad-hoc service provider currently serving the mobile client to provide the quality of service parameters negotiated at the beginning of the session. Alternatively, the current ad-hoc service provider may not be able to provide Internet access to the mobile client 108 for the entire duration of the session. It would not be uncommon for a mobile subscriber on an ad-hoc service provider that negotiates a 30 minute session with a mobile client to leave the vicinity 15 minutes into the session for whatever reason. In that event, the mobile client would need to select a new ad-hoc service provider from the active list for handoff.

In at least one configuration of a mobile client, the server control session manager module 1114 provides the active list to the server. In this configuration, the security module 310 in the server (see FIG. 3) can use the active list to pre-authenticate other ad-hoc service providers for handoff during the session between the mobile client and the current ad-hoc service provider. By pre-authenticating the ad-hoc service providers in the active list before the ad-hoc service provider currently serving the mobile client goes down, the time required to handoff the mobile client can be reduced.

The term “pre-authenticating” as used herein means authenticating a target ad-hoc service provider for handoff prior to receiving a message from the ad-hoc service provider currently serving the mobile client relating to the unavailability of the current ad-hoc service provider. The message may provide notification to the server that the current ad-hoc service provider has gone down and a hard handoff must be performed to another ad-hoc service provider if the session between the mobile client and the server is to be maintained. Alternatively, the message may provide notification to the server that the current ad-hoc service provider will be going down shortly, or that it can no longer provide the mobile client with the service agreed upon (e.g., quality of service). This provides the server with the option of enabling a soft handoff of the mobile client to another ad-hoc service provider.

Pre-authentication includes provisioning, prior to handoff, a potential new ad-hoc service provider and the mobile client with encryption/decryption keys that may be needed for communication between the potential new ad-hoc service provider and the mobile client.

Pre-authentication also includes provisioning, prior to handoff, the current ad-hoc service provider and the new ad-hoc service provider with encryption/decryption keys that may be needed for communication between the current ad-hoc service provider and the new ad-hoc service provider 106.

Pre-authentication also includes authorization of communication between the potential new ad-hoc service provider and the current ad-hoc service provider 106. It also includes authorization of communication between the potential new ad-hoc service provider and the mobile client.

FIG. 13 is a call flow diagram illustrating an example of a handoff using pre-authentication techniques. In this example, the handoff module 1118 may be used to manage and coordinate the activities of other software modules in the mobile client to perform a handoff from one ad-hoc service provider to another. For clarity of presentation, various signaling for the ad-hoc service providers 106 and mobile clients 108 to authenticate the server 110 and register with the server 110 will be omitted.

In step 1302, a connection may be initiated by an ad-hoc service provider 106, with the server 110 when the ad-hoc service provider 106, is mobile and desires to provide service. Extensible Authentication Protocol-Tunneled Transport Layer Security (EAP-TTLS) may be used for Authentication, Authorization and Accounting (AAA) and secure session establishment for this connection. In step 1304, a connection may be initiated by a mobile client 108 with the ad-hoc service provider 106, (hereinafter referred to as the “current ad-hoc service provider”) when the mobile client 108 requires Internet access. EAP-TTLS may also be used for AAA and secure session establishment. In particular, the ad-hoc service provider 106, sends the mobile client's credentials to the server 110 for EAP-AAA authentication. The EAP-TTLS authentication response from the server 110 is then used to generate a master shared key. Subsequently, a link encryption key may be established between the current ad-hoc service provider 106, and the mobile client 108. A SSL VPN session may then be established, in step 1306, between the mobile client 108 and the server 110.

It should be noted that information flow may be encrypted using encryption/decryption keys between any pair of nodes (where the nodes comprise the server 110, the current service provider 106₁, the target service provider 106₂, and the mobile client 108). Such encryption/decryption keys can be set up in the system when nodes in the system connect with the server. Typically symmetric key cryptography such as using AES may be used for such encryption or decryption for message-flow between any pair of nodes in the system.

In step 1308, the mobile client 108 provides the active list to the server 110. Alternatively, the mobile client 108 can send a report identifying ad-hoc service providers that it can hear accompanied by data indicating the signal strength measurements for each, and any other service parameters for the service providers that it can infer. The server 110 may use the report to generate the active list at its end.

The server 110 pre-authenticates one or more of the ad-hoc service providers in the active list. During pre-authentication of a target service provider 106₂ with a client 108, the server 110 provisions the target-service provider 106₂ with an encryption/decryption key for communication with the client 108. The server may additionally provision the target service provider 106₂ with an encryption/decryption key for communication with the current service provider 106₁. The server 110 also provisions the client 108 with the encryption/decryption key to communicate with the target service provider 106₂. The current service provider 106₁ can be provisioned by the server 110, either at the time of a handoff or anytime earlier, with the encryption/decryption key to communicate with the target service provider 106₂. The exact number of ad-hoc service providers in the active list that are pre-authenticated may depend on the admission control policies implemented by the server 110. By way of example, the server 110 may limit the number of ad-hoc service providers at a given location if it determines that additional ad-hoc service providers will adversely affect performance in the WWAN. Additional constraints may be imposed by the WWAN operators that may not want its mobile subscribers to provide service in a given geographic location depending on various network constraints. In any event, the server 110 pre-authenticates one or more ad-hoc service providers by providing each of them with a key to encrypt the data link between the mobile client 108 and the new ad-hoc service provider 106 following handoff. In FIG. 13, the server 110 is shown, in step 1310, providing the key to one ad-hoc service provider 106₂ (hereinafter referred to as the target ad-hoc service provider). In step 312, the server 110 also provides the key to the mobile client 108.

In step 1314, the mobile client 108 sends a message to the current ad-hoc service provider 106 requesting a handoff to an alternate service provider. Step 1314 is optional and is indicated by a dotted line from the client to the ad-hoc service provider.

In step 1316, the current ad-hoc service provider 106, sends a message to the server 110 requesting a handoff. Such a message is tagged with an identifier that indicates that the handoff was initiated by the mobile client 108, or that it was initiated by the current ad-hoc service provider 106₁. The message may be created at the current ad-hoc service provider 106₁ as a consequence of the current ad-hoc service provider's unavailability to continue to provide service to the mobile client. Alternatively, the message could have been created at the mobile client (step 1314), which needs to be sent by the current ad-hoc service provider 106₁ to the server 110. For a handoff that is initiated directly by the server, step 1316 is optional. For a handoff that is initiated by the mobile client 108, or by the ad-hoc service provider 106₁, in step 1318, the server 110 responds to step 1316 by sending a message back to current ad-hoc service provider 106, authorizing handoff. Alternatively, step 1318 could be a message from the server initiating a handoff, in the absence of a message 1316 from the current ad-hoc service provider 106₁. The message sent to the current ad-hoc service provider 106₁ may identify the target ad-hoc service provider 106₂ for handoff, or alternatively, allow the mobile client 108 to make the decision. In the latter case, the user on the mobile client 108 selects a target ad-hoc service provider for handoff in accordance with any admission control policy constraints imposed by the server 110. The server 110 may also provide the mobile client 108 with a quality metric for each ad-hoc service provider available to the mobile client. This quality metric may be used to assist the user on a mobile client 108 to select a new ad-hoc service provider for handoff. In the example shown in FIG. 13, the mobile client 108 selects the target ad-hoc service provider 106₂ for handoff.

In step 1320, the server may optionally send a message regarding the handoff to one or more target service providers 106₂. In step 1322, the handoff message received from the server 110 is sent by the current service provider 106, to the mobile client 108.

In step 1324, the mobile client 108 establishes a connection with the target ad-hoc service provider 106₂ by sending a message encrypted with a key. Since the target ad-hoc service provider 106₂ received the same key during the pre-authentication process, it can decrypt the message and establish a session with the mobile client 108 to complete the handoff. The target ad-hoc service provider 106₂ may also send a message back to the server 110, in step 1326, to signify that the handoff has been successfully completed.

Packets that have left the mobile client 108 may be in transit to the current ad-hoc service provider 106₁, or could be at the current ad-hoc service provider 106₁. These packets need to continue to be supported by the current ad-hoc service provider 106₁. Other packets that have left the mobile client 108 may be in transit to the server 110, or may be waiting at server 110 for further processing, or may be in transit to their final destination beyond the tunneling server. Future packets that leave the mobile client 108 are sent to the target ad-hoc service provider 106₂ after handoff. Packets that are destined to the mobile client 108 may be waiting at the server. Such packets are sent to the target ad-hoc service provider 106₂ after handoff. Other packets destined for the mobile client 108 may be in transit to the current ad-hoc service provider 106₁, or may be waiting at the current ad-hoc service provider 106₁, or may be in transit from the current service provider to the mobile client 108, and the current ad-hoc service provider 106₁ needs to continue to support such packets to be delivered to the mobile client 108. The delivery of such packets can be done over a wireless link or a multi-hop wireless path between the current ad-hoc service provider 106₁ and the target ad-hoc service provider 106₂. Alternatively, such packets can be delivered by the current ad-hoc service provider 106₁ to the server 110, which then sends them through the target ad-hoc service provider 106₂. Messages between the current ad-hoc service provider 106₁ and the target ad-hoc service provider 106₂ may be exchanged either through the server 110, or over a wireless link or multi-hop wireless path between the service providers.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application.

In various configurations of a telecommunications described thus far, a processor has been disclosed as one means for implementing a processing system in the server, ad-hoc service provider, and mobile client. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof.

In the various examples of processing systems provided throughout this disclosure, the machine-readable media is shown as part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the server, all which may be accessed by the processor through the network interface. Alternatively, or in addition to, the machine readable media, or any portion thereof, may be integrated into the processor, such as the case may be with cache and/or general register files.

The various software modules supported by the machine-readable media may reside in a single storage device or distributed across multiple memory devices. By way of example, a software module may be loaded into RAM from a hard drive when a triggering event occurs (e.g., a mobile node decides to become an ad-hoc service provider). During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the network interface, supporting circuitry (not shown), and at least a portion of the machine-readable media integrated into a single chip, or with one or more FPGAs (Field Programmable Gate Array), PLDs (Programmable Logic Device), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A mobile client, comprising:
a processing system configured to search for ad-hoc service providers with wireless backhauls to a network, the processing system being further configured to associate with one of the ad-hoc service providers detected in the search based on one or more parameters.

2. The mobile client of claim 1 wherein the processing system is further configured to receive the one or more parameters from said one of the ad-hoc service providers.

3. The mobile client of claim 1 wherein the one or more parameters includes a quality metric relating to performance of said one of the ad-hoc service providers during previous sessions with other mobile clients.

4. The mobile client of claim 1 wherein the one or more parameters include fee rates for access to the network.

5. The mobile client of claim 1 wherein the one or more parameters include at least one quality of service parameter.

6. The mobile client of claim 5 wherein said at least one quality of service parameter includes expected data rate of access to the network.

7. The mobile client of claim 5 wherein said at least one quality of service parameter includes expected duration of access to the network.

8. The mobile client of claim 5 wherein said at least one quality of service parameter includes latency of access to the network.

9. The mobile client of claim 5 wherein said at least one quality of service parameter includes frequency of access to the network.

10. The mobile client of claim 5 wherein said at least one quality of service parameter includes an amount of data that the mobile client is permitted to transfer through the network.

11. The mobile client of claim 1 wherein the processing system is further configured to support a tunnel between the mobile client and a server through said one of the ad-hoc service providers.

12. The mobile client of claim 11 wherein the tunnel comprises an encrypted tunnel for encrypted data that cannot be deciphered by the said one of the ad-hoc service providers.

13. The mobile client of claim 12 wherein the tunnel comprises a SSL VPN tunnel.

14. The mobile client of claim 12 wherein the tunnel comprises an IPsec tunnel.

15. The mobile client of claim 1 wherein the processing system is further configured to support an encrypted wireless link between the mobile client and said one of the ad-hoc service providers.

16. The mobile client of claim 1 wherein the processing system is further configured to register with a server to allow the mobile client to use said one of the ad-hoc service providers to access the network.

17. The mobile client of claim 1 wherein the processing system is further configured to provide credentials to a server to enable the server to authenticate the mobile client to use said one of the ad-hoc service providers to access the network.

18. The mobile client of claim 17 wherein the processing system is further configured to provide the credentials to the server through said one of the ad-hoc service providers.

19. The mobile client of claim 1 wherein the processing system is further configured to support a handoff of the mobile client from said one of the ad-hoc service providers to another one of the ad-hoc service providers detected in the search.

20. The mobile client of claim 19 wherein the processing system is further configured to support a tunnel between the mobile client and a server that is maintained during the handoff of the mobile client from said one of the ad-hoc service providers to said another one of the ad-hoc service providers.

21. The mobile client of claim 19 wherein the processing system is further configured to support an encrypted wireless link between the mobile client and said another one of the ad-hoc service providers during the handoff.

22. The mobile client of claim 1 wherein the processing system is further configured to maintain an active list of the ad-hoc service providers detected in the search.

23. The mobile client of claim 22 wherein the processing system is further configured to provide the active list to a server.

24. The mobile client of claim 1 wherein the processing system is further configured to receive video, audio and advertising services from a server.

25. The mobile client of claim 1 wherein the processing system is further configured to associate with a second one of the ad-hoc service providers detected in the search while associating with said one of the ad-hoc service providers.

26. The mobile client of claim 1 wherein the processing system is further configured to provide an access point to the network for other mobile clients.

27. A mobile client, comprising:
means for searching for ad-hoc service providers with wireless backhauls to a network; and
means for associating with one of the ad-hoc service providers detected in the search based on one or more parameters.

28. The mobile client of claim 27 further comprising means for receiving the one or more parameters from said one of the ad-hoc service providers.

29. The mobile client of claim 27 wherein the one or more parameters includes a quality metric relating to performance of said one of the ad-hoc service providers during previous sessions with other mobile clients.

30. The mobile client of claim 27 wherein the one or more parameters include fee rates for access to the network.

31. The mobile client of claim 27 wherein the one or more parameters include at least one quality of service parameter.

32. The mobile client of claim 31 wherein said at least one quality of service parameter includes expected data rate of access to the network.

33. The mobile client of claim 31 wherein said at least one quality of service parameter includes expected duration of access to the network.

34. The mobile client of claim 31 wherein said at least one quality of service parameter includes latency of access to the network.

35. The mobile client of claim 31 wherein said at least one quality of service parameter includes frequency of access to the network.

36. The mobile client of claim 31 wherein said at least one quality of service parameter includes an amount of data that the mobile client is permitted to transfer through the network.

37. The mobile client of claim 27 further comprising means for supporting a tunnel between the mobile client and a server through said one of the ad-hoc service providers.

38. The mobile client of claim 37 wherein the tunnel comprises an encrypted tunnel for encrypted data that cannot be deciphered by the said one of the ad-hoc service providers.

39. The mobile client of claim 38 wherein the tunnel comprises a SSL VPN tunnel.

40. The mobile client of claim 38 wherein the tunnel comprises an IPsec tunnel.

41. The mobile client of claim 27 further comprising means for supporting an encrypted wireless link between the mobile client and said one of the ad-hoc service providers.

42. The mobile client of claim 27 further comprising means for registering with a server to allow the mobile client to use said one of the ad-hoc service providers to access the network.

43. The mobile client of claim 27 further comprising means for providing credentials to a server to enable the server to authenticate the mobile client to use said one of the ad-hoc service providers to access the network.

44. The mobile client of claim 43 wherein the means for providing the credentials to the server is configured to provide such credentials through said one of the ad-hoc service providers.

45. The mobile client of claim 27 further comprising means for supporting a handoff of the mobile client from said one of the ad-hoc service providers to another one of the ad-hoc service providers detected in the search.

46. The mobile client of claim 45 further comprising means for supporting a tunnel between the mobile client and a server that is maintained during the handoff of the mobile client from said one of the ad-hoc service providers to said another one of the ad-hoc service providers.

47. The mobile client of claim 45 further comprising means for supporting an encrypted wireless link between the mobile client and said another one of the ad-hoc service providers during the handoff.

48. The mobile client of claim 27 further comprising means for maintaining an active list of the ad-hoc service providers detected in the search.

49. The mobile client of claim 48 further comprising means for providing the active list to a server.

50. The mobile client of claim 27 further comprising means for receiving video, audio and advertising services from a server.

51. The mobile client of claim 27 further comprising means for associating with a second one of the ad-hoc service providers detected in the search while associating with said one of the ad-hoc service providers.

52. The mobile client of claim 27 further comprising means for providing an access point to the network for other mobile clients.

53. A method of accessing a network through an ad-hoc service provider, comprising:
searching for ad-hoc service providers with wireless backhauls to a network; and
associating with one of the ad-hoc service providers detected in the search based on one or more parameters.

54. The method of claim 53 further comprising receiving the one or more parameters from said one of the ad-hoc service providers.

55. The method of claim 53 wherein the one or more parameters includes a quality metric relating to performance of said one of the ad-hoc service providers during previous sessions with other mobile clients.

56. The method of claim 53 wherein the one or more parameters include fee rates for access to the network.

57. The method of claim 53 wherein the one or more parameters include at least one quality of service parameter.

58. The method of claim 57 wherein said at least one quality of service parameter includes expected data rate of access to the network.

59. The method of claim 57 wherein said at least one quality of service parameter includes expected duration of access to the network.

60. The method of claim 57 wherein said at least one quality of service parameter includes latency of access to the network.

61. The method of claim 57 wherein said at least one quality of service parameter includes frequency of access to the network.

62. The method of claim 57 wherein said at least one quality of service parameter includes an amount of data that the mobile client is permitted to transfer through the network.

63. The method of claim 53 further comprising supporting a tunnel between the mobile client and a server through said one of the ad-hoc service providers.

64. The method of claim 63 wherein the tunnel comprises an encrypted tunnel for encrypted data that cannot be deciphered by the said one of the ad-hoc service providers.

65. The method of claim 64 wherein the tunnel comprises a SSL VPN tunnel.

66. The method of claim 64 wherein the tunnel comprises an IPsec tunnel.

67. The method of claim 53 further comprising supporting an encrypted wireless link between the mobile client and said one of the ad-hoc service providers.

68. The method of claim 53 further comprising registering with a server to allow the mobile client to use said one of the ad-hoc service providers to access the network.

69. The method of claim 53 further comprising providing credentials to a server to enable the server to authenticate the mobile client to use said one of the ad-hoc service providers to access the network.

70. The method of claim 69 wherein the credentials are provided to the server through said one of the ad-hoc service providers.

71. The method of claim 53 further comprising supporting a handoff of the mobile client from said one of the ad-hoc service providers to another one of the ad-hoc service providers detected in the search.

72. The method of claim 71 further comprising supporting a tunnel between the mobile client and a server that is maintained during the handoff of the mobile client from said one of the ad-hoc service providers to said another one of the ad-hoc service providers.

73. The method of claim 71 further comprising means supporting an encrypted wireless link between the mobile client and said another one of the ad-hoc service providers during the handoff.

74. The method of claim 53 further comprising maintaining an active list of the ad-hoc service providers detected in the search.

75. The method of claim 74 further comprising providing the active list to a server.

76. The method of claim 53 further comprising receiving video, audio and advertising services from a server.

77. The method of claim 53 further comprising associating with a second one of the ad-hoc service providers detected in the search while associating with said one of the ad-hoc service providers.

78. The method of claim 53 further comprising providing an access point to the network for other mobile clients.

79. A machine-readable medium comprising instructions executable by a processing system in a mobile client, the instructions comprising:
code for searching for ad-hoc service providers with wireless backhauls to a network; and
code for associating with one of the ad-hoc service providers detected in the search based on one or more parameters.

80. The machine-readable medium of claim 79 wherein the instructions further comprises code for receiving the one or more parameters from said one of the ad-hoc service providers.

81. The machine-readable medium of claim 79 wherein the one or more parameters includes a quality metric relating to performance of said one of the ad-hoc service providers during previous sessions with other mobile clients.

82. The machine-readable medium of claim 79 wherein the one or more parameters include fee rates for access to the network.

83. The machine-readable medium of claim 79 wherein the one or more parameters include at least one quality of service parameter.

84. The machine-readable medium of claim 83 wherein said at least one quality of service parameter includes expected data rate of access to the network.

85. The machine-readable medium of claim 83 wherein said at least one quality of service parameter includes expected duration of access to the network.

86. The machine-readable medium of claim 83 wherein said at least one quality of service parameter includes latency of access to the network.

87. The machine-readable medium of claim 83 wherein said at least one quality of service parameter includes frequency of access to the network.

88. The machine-readable medium of claim 83 wherein said at least one quality of service parameter includes an amount of data that the mobile client is permitted to transfer through the network.

89. The machine-readable medium of claim 79 wherein the instructions further comprises code for supporting a tunnel between the mobile client and a server through said one of the ad-hoc service providers.

90. The machine-readable medium of claim 89 wherein the tunnel comprises an encrypted tunnel for encrypted data that cannot be deciphered by the said one of the ad-hoc service providers.

91. The machine-readable medium of claim 90 wherein the tunnel comprises a SSL VPN tunnel.

92. The machine-readable medium of claim 90 wherein the tunnel comprises an IPsec tunnel.

93. The machine-readable medium of claim 79 wherein the instructions further comprises code for supporting an encrypted wireless link between the mobile client and said one of the ad-hoc service providers.

94. The machine-readable medium of claim 79 wherein the instructions further comprises code for registering with a server to allow the mobile client to use said one of the ad-hoc service providers to access the network.

95. The machine-readable medium of claim 79 wherein the instructions further comprises code for providing credentials to a server to enable the server to authenticate the mobile client to use said one of the ad-hoc service providers to access the network.

96. The machine-readable medium of claim 95 wherein the code for providing credentials to the server is configured to provide such credentials through said one of the ad-hoc service providers.

97. The machine-readable medium of claim 79 wherein the instructions further comprises code for supporting a handoff of the mobile client from said one of the ad-hoc service providers to another one of the ad-hoc service providers detected in the search.

98. The machine-readable medium of claim 97 wherein the instructions further comprises code for supporting a tunnel between the mobile client and a server that is maintained during the handoff of the mobile client from said one of the ad-hoc service providers to said another one of the ad-hoc service providers.

99. The machine-readable medium of claim 97 wherein the instructions further comprises code for supporting an encrypted wireless link between the mobile client and said another one of the ad-hoc service providers during the handoff.

100. The machine-readable medium of claim 79 wherein the instructions further comprises code for maintaining an active list of the ad-hoc service providers detected in the search.

101. The machine-readable medium of claim 100 wherein the instructions further comprises code for providing the active list to a server.

102. The machine-readable medium of claim 79 wherein the instructions further comprises code for receiving video, audio and advertising services from a server.

103. The machine-readable medium of claim 79 wherein the instructions further comprises code for associating with a second one of the ad-hoc service providers detected in the search while associating with said one of the ad-hoc service providers.

104. The machine-readable medium of claim 79 wherein the instructions further comprises code for providing an access point to the network for other mobile clients.
